(19) United States
(12) Patent Application Publication
(10) Pub. No.: US 2009/0268429 A1
(43) Pub. Date: Oct. 29, 2009

(54) FLUORESCENT LAMP, MANUFACTURING METHOD THEREFOR, LIGHTING DEVICE USING THE FLUORESCENT LAMP, AND DISPLAY DEVICE

(76) Inventors: Nozomu Hashimoto, Osaka (JP); Kazuhiro Matsuo, Osaka (JP); Katsumi Itagaki, Kyoto (JP); Hideki Wada, Osaka (JP); Toshihiro Terada, Hyogo (JP); Tomokazu Matsuura, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/067,514

(22) PCT Filed: Nov. 8, 2006
(86) PCT No.: PCT/JP2006/322692

§ 371 Date: Mar. 20, 2008

(30) Foreign Application Priority Data
Nov. 10, 2005 (JP) 2005-326471
Nov. 11, 2005 (JP) 2005-327480
Dec. 1, 2005 (JP) 2005-348403
Jan. 21, 2006 (JP) 2006-023672

(51) Int. Cl. G09F 13/08; H01J 63/04; H01J 1/63; H01J 1/70; H01J 61/30; F21V 21/00; B05D 5/06

(52) U.S. Cl. 362/97.1; 313/485; 313/487; 313/489; 313/493; 362/249.01; 427/67

(57) ABSTRACT

A fluorescent lamp includes a glass container (204) having mercury enclosed therein, and a phosphor layer (202) formed on an inner side of the glass container (204). The phosphor layer (202) includes phosphor particles (202a) and rod-shaped bodies (202b) composed of a metal oxide and spanning between the phosphor particles. The rod-shaped bodies (202b) have a thickness of, for example, 1.5 [μm] or less. Pairs of adjacent phosphor particles may be spanned by more than one rod-shaped body.

### TECHNICAL FIELD

The present invention relates to a fluorescent lamp, a manufacturing method therefor, a lighting device using the fluorescent lamp, and a display device. The present invention discloses in particular a structure of a phosphor layer.

### BACKGROUND ART

Generally, in fluorescent lamps of cold-cathode fluorescent lamps and the like, a phosphor layer including phosphors is formed on an inner side of a translucent container composed of a glass tube or the like.

Mercury and an ionizing gas including more than one type of rare gas are enclosed in the glass tube. Electrodes are disposed in the glass tube near the ends thereof.

Upon initiating a positive column discharge between the electrodes, the mercury in the glass tube is excited and ionized, and the excitation of the mercury is accompanied by the generation of resonance lines (wavelengths of 185 [nm], 254 [nm], 313 [nm] and 365 [nm]).

These resonance lines are converted into visible light by the phosphor layer formed on the inner side of the glass tube.

In recent years, from the viewpoint of environmental protection, there has been increasing demand to reduce the amount of mercury used in fluorescent lamps. There is therefore a need for the development of technology that suppresses the amount of mercury that is consumed in glass tubes. However, it is known that as the usage time passes, the mercury in fluorescent lamps is consumed as a result of the following phenomenon. When a fluorescent lamp is operated, the mercury diffuses into the glass tube, and reacts with sodium (Na) which diffused from the glass tube into the phosphor material, to form an amalgam. Mercury is therefore consumed due to adsorption to the phosphor material. The consumed mercury readily absorbs visible light, which is one of the causes for reduction in luminance.

FIG. 13 is a partial cross-sectional view of a phosphor layer of a conventional fluorescent lamp having a structure that attempts to solve the problem of mercury consumption (e.g., see International Publication WO 2002/047112 pamphlet, and Japanese Patent Application Publication No. 2004-6399). As shown in FIG. 13, a phosphor layer 100 is formed by depositing phosphor particles 120 on a glass tube 130, and portions of surfaces of the phosphor particles 120 are covered by metal oxide bodies 110. The metal oxide bodies 110 are disposed between adjacent phosphor particles to form a link therebetween, and gaps between the phosphor particles have become narrower. The amount of mercury that penetrates into the phosphor layer 100 is reduced due to the presence of the metal oxide bodies 110, thereby suppressing the consumption of mercury resulting from adsorption to the phosphor material and the like.

However, given that the metal oxide bodies 110 have a clumped shape, light converted by the phosphor particles is blocked by the clump-shaped metal oxide bodies 110, thereby making it difficult for light to escape from the glass tube 130. Therefore, although the conventional lamps can suppress the consumption of mercury, their initial luminance is low.

The present invention aims to provide a fluorescent lamp, a manufacturing method therefor, a lighting device using the fluorescent lamp, and a display device that achieve both the suppression of mercury consumption and high initial luminance.

### DISCLOSURE OF THE INVENTION

A fluorescent lamp pertaining to the present invention includes: a glass container having mercury enclosed therein; and a phosphor layer formed on an inner side of the glass container, the phosphor layer containing a plurality of phosphor particles, and a plurality of rod-shaped bodies that include a metal oxide and span between the plurality of phosphor particles.

According to this structure, light converted by the phosphor particles is readily transmitted out of the glass container since the phosphor particles included in the phosphor layer are spanned by rod-shaped bodies that include a metal oxide. The penetration of mercury into the phosphor layer is prevented by the metal oxide rod-shaped bodies, and the consumption of mercury due to adsorption to the phosphors etc. is suppressed. According to the present invention, it is therefore possible to provide a fluorescent lamp that achieves both the suppression of mercury consumption and high initial luminance.

### BRIEF DESCRIPTION OF THE DRAWINGS

FIG. 1 is a cross-sectional view showing an exemplary fluorescent lamp pertaining to embodiment 1, including a tube axis;

FIG. 2 is an enlarged conceptual diagram showing an exemplary phosphor layer constituting the fluorescent lamp pertaining to embodiment 1;

FIG. 3 is an enlarged conceptual diagram showing another exemplary phosphor layer constituting the fluorescent lamp pertaining to embodiment 1;

FIG. 4 is a flowchart showing an exemplary manufacturing method for a fluorescent lamp pertaining to embodiment 2;

FIG. 5 is shows a reaction process whereby a metal compound becomes a metal oxide;

FIG. 6 is an exploded perspective view showing a structure of a backlight unit pertaining to embodiment 3;

FIG. 7 is a planar view of an exemplary lighting apparatus pertaining to embodiment 3;

FIG. 8 is a cross-sectional view taken along a line A-A of FIG. 7;

FIG. 9 is a perspective view of an exemplary lighting apparatus pertaining to embodiment 3;

FIG. 10 is a perspective conceptual diagram showing an exemplary display apparatus pertaining to embodiment 3;

FIG. 11 is an HRSEM photograph of a phosphor layer constituting a fluorescent lamp of working example 1;

FIG. 12 is a graph showing a relationship between humidity inside a glass tube during drying and a number of contact points between a phosphor layer and the glass tube;

FIG. 13 is an enlarged conceptual diagram of an exemplary phosphor layer constituting a conventional fluorescent lamp;

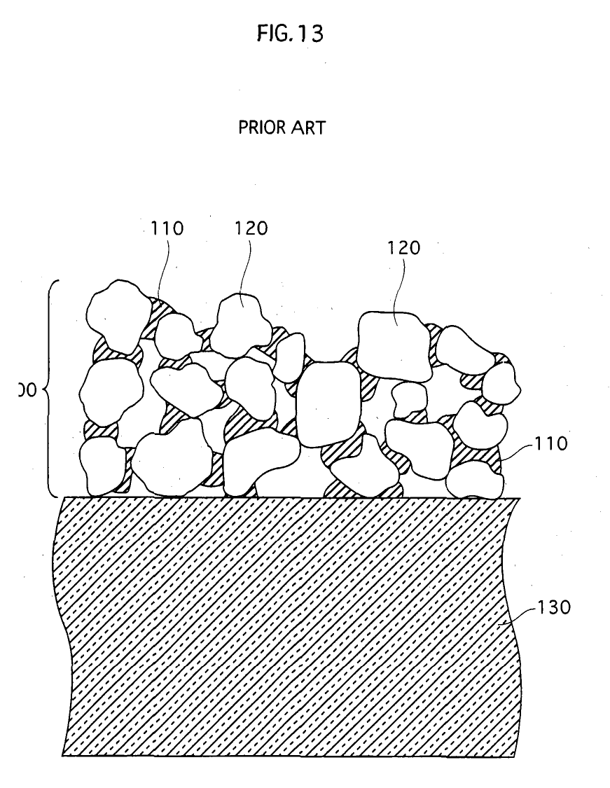

FIG. 14 is a partially cut-out perspective view showing a cold cathode fluorescent lamp pertaining to embodiment 4;

FIG. 15 is an enlarged view of a portion A in FIG. 14;

FIG. 16 shows various conditions of a working example and comparative examples common to an experiment regarding luminance and color balance;

FIG. 17 shows a relationship between protective film content for phosphor particles and initial emission luminance of a fluorescent lamp;

FIG. 18 shows results of an experiment examining variations in emission luminance maintenance rates and variations in color balance;

FIG. 19 is a graph showing emission luminance maintenance rates of fluorescent lamps pertaining to embodiment 4;

FIG. 20 is a schematic view of phosphor particles pertaining to embodiment 4;

FIG. 21 is a schematic view of a phosphor layer pertaining to embodiment 5;

FIG. 22 is a schematic view of a phosphor layer in a conventional fluorescent lamp;

FIG. 23A is a cross-sectional view of a cold cathode fluorescent lamp pertaining to embodiment 6, including a tube axis, and FIG. 23B is used in a description of measurements of an electrode that is a constituent member of the cold cathode fluorescent lamp;

FIG. 24 is an enlarged schematic view of a phosphor layer pertaining to the cold cathode fluorescent lamp;

FIG. 25 shows part of a manufacturing process for the cold cathode fluorescent lamp;

FIG. 26 is a half cross-sectional view showing an external electrode fluorescent lamp pertaining to embodiment 7;

FIG. 27 is an enlarged schematic view of a protective layer and a phosphor layer of the external electrode fluorescent lamp;

FIG. 28 is a cross-sectional view of an external electrode fluorescent lamp pertaining to embodiment 8, including a tube axis;

FIG. 29 shows part of steps in a manufacturing method for the external electrode fluorescent lamp;

FIG. 30 shows part of steps in the manufacturing method for the external electrode fluorescent lamp;

FIG. 31 is a photograph of an end portion of an external electrode fluorescent lamp pertaining to conventional technology; and

FIGS. 32A and 32B are used in descriptions of a second sealing experiment and results thereof.

### BEST MODE FOR CARRYING OUT THE INVENTION

Embodiments of the present invention are described below.

In a fluorescent lamp of the present invention, phosphor particles are inter-spanned by rod-shaped bodies that include a metal oxide. Here, “rod-shaped body” refers to a body that has a column shape and whose diameter is smaller than a spanned distance. Also, in an exemplary fluorescent lamp of the present invention, a pair of adjacent phosphor particles may be spanned by a plurality of rod-shaped bodies. Here, the “thickness” (diameter) of a rod-shaped body is no more than 1.5 [μm]. Here, the thickness of a rod-shaped body can be seen when observed using a high resolution scanning electron microscope (HRSEM), and refers to the thickness at ½ of the longitudinal length of the rod-shaped body (the length in the inter-phosphor particle direction).

It is preferable for a metal oxide to be at least one member selected from among, specifically, Y, La, Hf, Mg, Si, Al, P, B, V and Zr. It is particularly preferable for the metal to be Y. The consumption of mercury is further reduced if the metal oxide contains an yttrium oxide such as Y₂O₃.

In the exemplary fluorescent lamp of the present invention, a glass container is tubular glass with a small inner diameter of 1.2 [mm] to 13.4 [mm]. Given that phosphors readily degrade in fluorescent lamps with a small diameter, this degredation can be suppressed by employing a phosphor layer including phosphor particles that are spanned by rod-shaped bodies composed of a metal oxide.

In an exemplary manufacturing method of the fluorescent lamp of the present invention, it is preferable to use an organic metal compound such as yttrium carboxylate as the metal compound. In this case, it is preferable to supply a gas with a humidity (relative humidity) of 10[%] to 40[%] at 25 [° C.] into the glass container while performing vaporization of a solvent in a phosphor layer formation step. It is unclear why, but uniformity of thickness etc. of the phosphor layer deteriorates if the humidity in the glass container is too low, and vaporization of the solvent takes too long if the humidity is too high, thereby reducing production efficiency. Performing vaporization of the solvent by supplying the gas with a humidity of 10[%] to 40[%] at 25 [° C.] into the glass container enables efficient formation of a phosphor layer with excellent uniformity. Although differing according to the type of solvent included in the coating material, it is usually suitable for an atmospheric temperature during vaporization of the solvent to be 25 [° C.] to 50 [° C.].

The exemplary fluorescent lamp of the present invention is preferably used as, for example, a light source included in a lighting device. One example of the lighting device includes, for example, a plurality of the exemplary fluorescent lamps of the present invention, which are stored in a casing that includes a window able to transmit light emitted by the fluorescent lamps.

The exemplary lighting device is preferably used as, for example, a backlight unit included in a display device of a liquid crystal display device or the like. In one example of the liquid crystal display device, the lighting device is, for example, disposed on a back face of the display panel.

Examples of the present invention are described below with reference to the drawings.

### Embodiment 1

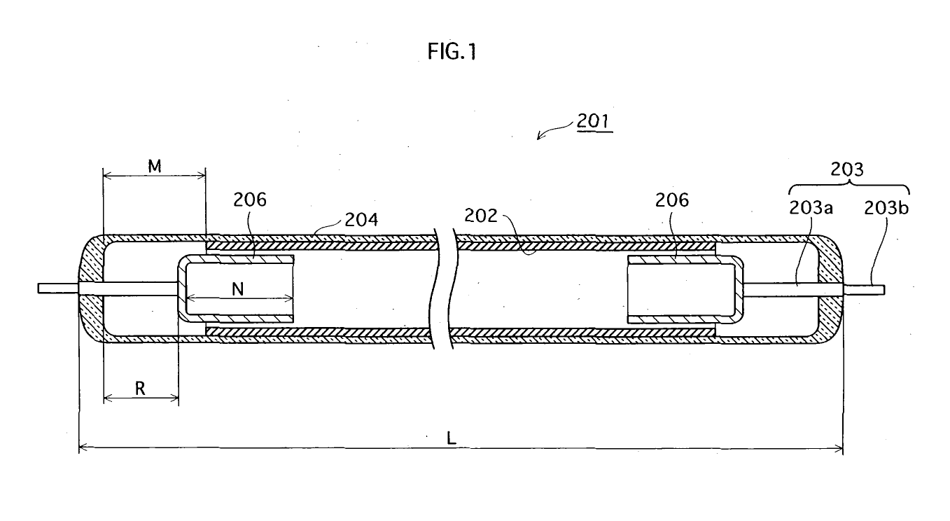

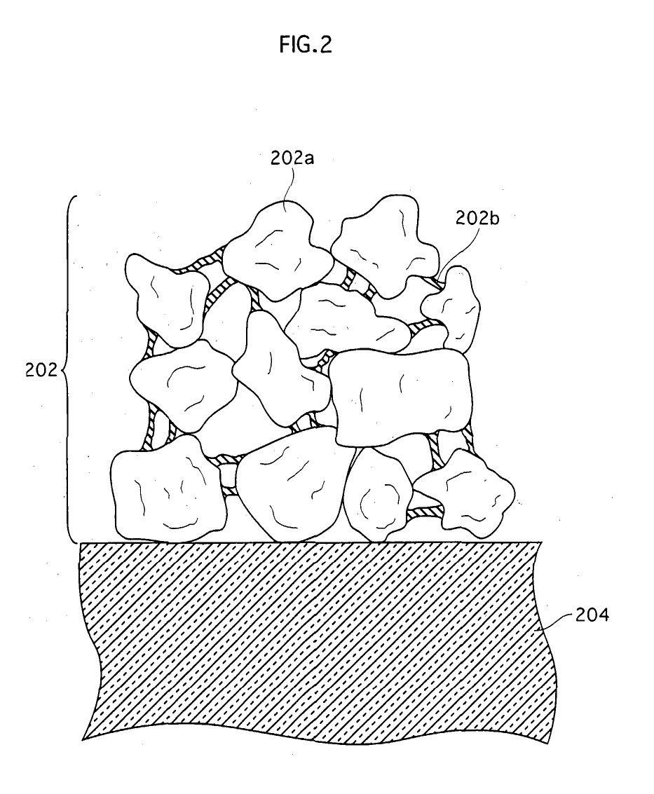

The following describes an exemplary fluorescent lamp of the present invention. FIG. 1 is a cross-sectional view, including a tube axis, of the exemplary fluorescent lamp of the present embodiment, and FIG. 2 is an enlarged conceptual view of a phosphor layer included in the fluorescent lamp shown in FIG. 1.

A fluorescent lamp 201 shown in FIG. 1 is a cold cathode fluorescent lamp. In the fluorescent lamp 201, ends of a glass tube 204, which has a circular cross section cut vertically with respect to the tube axis, are each hermitically sealed by lead wires 203, and inner ends of the lead wires 203 inside the glass tube 204 are each connected to electrodes 206. A phosphor layer 202 has been formed on a predetermined area of an inner side of the glass tube 204.

As shown in FIG. 2, the phosphor layer 202 includes phosphor particles 202a, and the phosphor particles 202a are spanned by rod-shaped bodies 202b that include a metal oxide. The rod-shaped bodies 202b have a thickness of, for example, 1.5 [μm] or less. There are cases in which a pair of adjacent phosphor particles 202a is spanned by a plurality of the rod-shaped bodies 202b. The presence of the rod-shaped bodies 202b narrows gaps between the phosphor particles 202a, and suppresses the penetration of mercury into the phosphor layer 202. This therefore suppresses the consumption of mercury from adsorption to the phosphor particles 202a. Also, given that the metal oxide bodies disposed between the phosphor particles 202a and spanning therebetween are rod-shaped, light converted by the phosphor layer 202 is readily transmitted outside the glass tube 204. According to this structure, the fluorescent lamp 100 of the present embodiment achieves both high luminance and the suppression of the consumption of mercury, as is shown in working examples mentioned hereinafter.

It is preferable for the metal oxide to be at least one member selected from among, for example, Y, La, Hf, Mg, Si, Al, P, B, V and Zr. Among these, Zr, Y, Hf and the like are preferable since their coupling energy with an oxygen atom exceeds 10.7×10⁻⁹ [J]. This 10.7×10⁻⁹ [J] corresponds to the photon energy of 185-[nm] ultraviolet radiation, which is one of the resonance lines generated along with the excitation of mercury. Using, for example, ZrO₂, Y₂O₃, or HfO₂ as the metal oxide including a metal whose coupling energy with an oxygen atom exceeds 10.7×10⁻⁹ [J] improves the resistance of the metal oxide to exposure to 185-[nm] ultraviolet radiation. Also, using a metal oxide that includes Y₂O₃ further reduces the consumption of mercury, which is preferable.

SiO₂, Al₂O₃, HfO₂, or the like may be used as the metal oxide. These have a high (substantially 100[%]) transmissivity for light with a wavelength of 254 [nm]. Phosphors emit visible light by receiving 254-[nm] light. Therefore, using a metal oxide that has a high transmissivity for 254-[nm] light increases luminous efficiency, which is preferable.

Note that ZrO₂ has a transmissivity of approximately 95[%] for 254-[nm] light, and V₂O₅, Y₂O₃ and NbO₅ have a transmissivity of approximately 85[%] for 254-[nm] light. Y₂O₃ and ZrO₂ have a low transmissivity for light with a wavelength of 200 [nm] or less, which are specifically less than 30[%] and 20[%] respectively. For this reason, Y₂O₃ and ZrO₂ have a large effect of blocking 185-[nm] light that degrades phosphors, which is preferable.

The phosphor layer is formed on the inner side of the glass tube 204, except for, for example, the ends thereof. While there are no particular restrictions, it is suitable for a distance M from an end surface of the glass tube 204 to the phosphor layer to be, for example, 4 [mm] to 7 [mm].

There are no particular restrictions on the composition of phosphors included in the phosphor layer, as long as phosphors emitting red light, phosphors emitting green light, and phosphors emitting blue light are included. For example, (Y₂O₃:Eu³⁺), (YVO₄:Eu³⁺), or the like is used as phosphors emitting red light, (LaPO₄:Ce³⁺, Tb³⁺), (BaMg₂Al₁₆O₂₇:Eu²⁺, Mn²⁺), or the like is used as phosphors emitting green light, and (BaMg₂Al₁₆O₂₇:Eu²⁺), (Sr, Ca, Ba)₅, (PO₄)₃Cl:Eu²⁺, or the like is used as phosphors emitting blue light. A mixture ratio of these phosphors need only be adjusted such that the color temperature is, for example, 3,000 [K] or more.

In addition to phosphor particles and a metal oxide, the phosphor layer 202 may include a thickening agent, a binding agent, etc. as necessary.

A material of the glass tube 204 is, for example, a hard borosilicate glass with the following composition.

SiO₂: 68[%] to 77[%]

Al₂O₃: 1[%] to 6[%]

B₂O₃: 14[%] to 18[%]

Li₂O: 0[%] to 0.6[%]

Na₂O: 1[%] to 5[%]

K₂O: 1[%] to 6[%]

MgO: 0.3[%] to 0.6[%]

CaO: 0.6[%] to 1[%]

SrO: 0[%] to 0.5[%]

BaO: 0[%] to 1.3[%]

Sb₂O₃: 0[%] to 0.7[%]

As₂O₃: 0[%] to 0.2[%]

TiO₂: 0.4[%] to 6[%]

ZrO₂: 0[%] to 0.2[%]

Note that the glass tube 204 is not limited to borosilicate glass. Lead glass, lead-free glass, soda glass, or the like may be used. In this case, it is possible to improve an in-dark starting characteristic of the lamp. Specifically, glasses such as the above contain a large amount of alkali metal oxides such as sodium oxide (Na₂O), and in the exemplary case of sodium oxide, the sodium (Na) component elutes to the inner side of the glass tube over time. The sodium that elutes to the inner ends of the glass tube (without a protective film) is thought to contribute to improvement in the in-dark starting characteristic since sodium has a low electronegativity.

For example, if the alkali metal oxide is sodium oxide, it is preferable for 5 [mol %] to 20 [mol %] of sodium oxide to be included in the glass tube material. If the sodium oxide content is less than 5 [mol %], there is a higher probability that the in-dark starting time will increase, and if more than 20 [mol %], there may be problems such as reduced luminance from blackening (turning dark brown) or whitening of the glass tube due to long-term use, and a reduction in the strength of the glass tube. In particular, in the case of an external electrode fluorescent lamp such as in later-mentioned embodiments it is preferable for 3 [mol %] to 20 [mol %] inclusive of the alkali metal oxide to be included in the glass tube material.

Also, it is preferable to use lead-free glass if environmental protection is taken into consideration. However, lead-free glass may acquire lead as an impurity in the manufacturing process. Lead-free glass is therefore defined as glass that contains lead at an impurity level of 0.1 [wt %] or less.

While there are no particular restrictions on measurements of the glass tube, it is suitable for a tube length L to be, for example, 39 [mm] to 1300 [mm]. If the glass tube is composed of borosilicate glass, an inner diameter of 1.2 [mm] to 3.8 [mm] and an outer diameter of 1.8 [mm] to 4.8 [mm] are preferable considering cost and the like. If the glass tube is composed of soda glass, an inner diameter of 3.0 [mm] to 13.4 [mm] and an outer diameter of 4.0 [mm] to 15.0 [mm] are preferable considering mechanical strength. Electrical current density is greater in the fluorescent lamp 100 using the glass tube 204 with a small inner diameter, compared with a fluorescent lamp using a glass tube with a larger inner diameter. This narrowing of the diameter and increase in current density cause an increase in the proportion of emitted 185-[nm] ultraviolet radiation, which is one of the resonance lines generated along with the excitation of mercury. Given that shorter-wavelength resonance lines in particular degrade phosphors, an increase in the proportion of emitted shorter-wavelength resonance lines causes an increase in the luminance reduction rate during operation of the fluorescent lamp 100. The percentage of mercury consumed also increases, thereby further increasing the luminance reduction rate. Employing a phosphor layer in which phosphor particles are spanned by rod-shaped bodies composed of a metal oxide is, therefore, very beneficial for the fluorescent lamp 100 whose glass tube 204 has a small inner diameter of, for example, 1.2 [mm] to 13.4 [mm].

An appropriate amount of, for example, mercury (not depicted) and one or more types of rare gases are enclosed in the glass tube 204. It is suitable for, for example, 1 [mg] to 4.8 [mg] of mercury to be enclosed in the glass tube 204. The rare gases may be, for example, argon (Ar) gas, neon (Ne) gas, or the like. It is suitable for a mixture ratio of these gases to be, for example, 90 to 95 [vol %] of Ne gas and 5 to 10 [vol %] of Ar gas. It is suitable for a gas pressure while the fluorescent lamp 100 is not operated to be, for example, 6.3 [kPa] to 20 [kPa].

The lead wires 203 are composed of, for example, inner lead wires 203a disposed in the glass tube 204, and outer lead wires 203b that are joined to the lead wires 203a and disposed outside the glass tube 204. The inner lead wires 203a are composed of, for example, tungsten (W), and the outer lead wires 203b are composed of, for example, nickel (Ni).

The electrodes 206 are bottomed cylinders, and also called hollow electrodes. The electrodes 206 are joined to the lead wires 203 by a laser welding method or the like. The electrodes 206 include an emitter (not depicted) that is retained on an inner side of the bottomed cylinder. The bottomed cylinder is composed of, for example, niobium (Nb), nickel (Ni), molybdenum (Mo), or the like, and Cs₂AlO₃ or the like is used in the emitter.

A size of the electrodes 206 is set such that their effective surface area contributing to discharge is a desired size. For example, the electrodes 206 may have a length N in the axial direction of 3.1 [mm] to 5.6 [mm], and an inner diameter of 1 [mm] to 2.8 [mm]. It is suitable for a distance R from an end surface of the glass tube 204 to a corresponding electrode 206 to be 5 [mm] to 8.3 [mm].

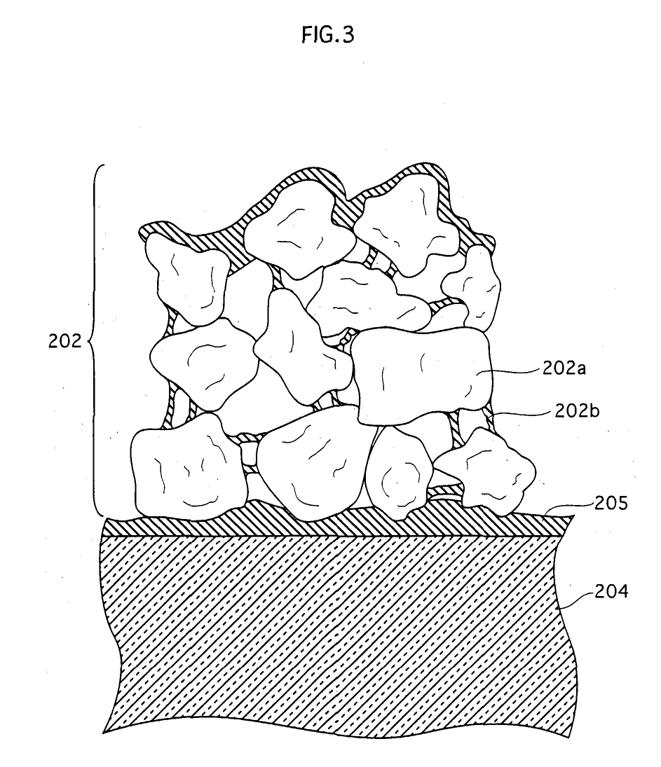

Also, the phosphor particles 202a at a face of the phosphor layer 202 on the discharge space side, as shown in FIG. 3, need not be exposed. In other words, the phosphor particles 202a may be embedded in the phosphor layer 202 such that their surfaces do not form a part of the face on the discharge space side, and such face may be formed from a metal oxide or the like. In this case, the phosphor particles 202a are isolated from the mercury, and adsorption of the mercury to the phosphor particles 202a is more effectively suppressed. Using a metal oxide whose transmissivity for 254-[nm] light is high (e.g., 85[%] or more) as the metal oxide forming the face on the discharge space side enables 254-[nm] light to reach the phosphor particles 202a to cause them to emit light. In this case, it is preferable for the metal oxide to be, for example, SiO₂, Al₂O₃, HfO₂, ZrO₂, V₂O₅, Y₂O₃, NbO₅, or the like.

Also, a continuous metal oxide layer 105 may be formed between the glass tube 204 and the phosphor layer 202, as shown in FIG. 3. In this case as well, the glass tube 204 is isolated from the mercury, thereby suppressing the consumption of mercury by being diffused in the glass tube 204. If the glass tube 204 is composed of, for example, soda glass which includes a large proportion of Na, it is possible to suppress the generation of an amalgam due to a reaction between the Na and the mercury. The metal oxide constituting the metal oxide layer 105 may be at least one member selected from among, for example, Y, La, Hf, Mg, Si, Al, P, B, V and Zr. The metal oxide constituting the metal oxide layer 105 may be the same metal oxide as is included in the phosphor layer 202, or a different metal oxide, but it is particularly preferable to use SiO₂, Al₂O₃ or the like.

Although described using the example of a cold-cathode fluorescent lamp, the fluorescent lamp of the present invention is not limited to this. For example, the present invention may be similarly applied to an external electrode fluorescent lamp, an internal-external electrode fluorescent lamp, a hot-cathode fluorescent lamp, a compact fluorescent lamp, an electrodeless fluorescent lamp using an external dielectric coil, or the like.

### Embodiment 2

The following describes an exemplary manufacturing method for the fluorescent lamp 201 described in embodiment 1.

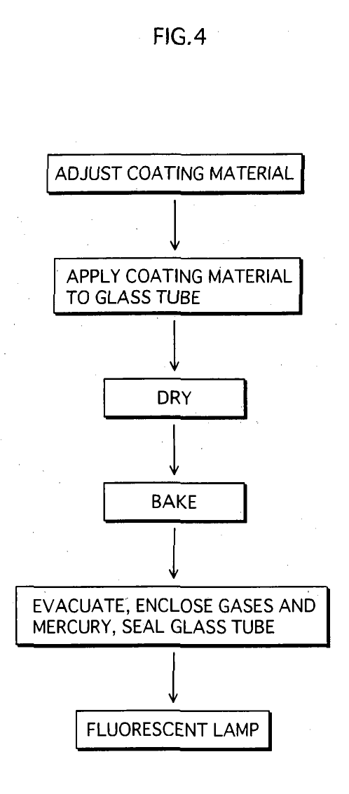

FIG. 4 is a flowchart showing an exemplary manufacturing method for the fluorescent lamp of the present embodiment. As shown in FIG. 4, a coating material for forming the phosphor layer 202 is first adjusted. Adjusting the coating material involves dispersing a predetermined amount of phosphor particles in a solvent, and adding and dissolving a predetermined amount of a metal compound into the obtained suspension. The solvent used here includes two or more types of organic solvents that have different boiling points. More specifically, the two or more types of solvents with different boiling points need only be appropriately selected from among butyl acetate (boiling point is 120 [° C.] to 126.5 [° C.]), ethanol (boiling point is 78.3 [° C.]), methanol (boiling point is 64.6 [° C.]), turpentine (boiling point is 150 [° C.] to 200 [° C.]), or the like.

Regarding a compound ratio of the two or more types of solvents, it is suitable for a higher boiling point solvent to be 0.1 [wt %] to 10 [wt %] based on 100 [wt %] of a lower boiling point solvent. It is more suitable for the high boiling point solvent to be 2 [wt %] to 6 [wt %]. It is possible to adjust the average thickness of the rod-shaped bodies to a desired value by adjusting the mixture ratio of the lower boiling point solvent and the higher boiling point solvent.

While there are no particular restrictions on the amount of the metal compound to be added, it is preferable for the metal compound to be added such that, for example, the metal oxide obtained by a reaction with the metal compound makes up approximately 0.1 [wt %] to 0.6 [wt %] of the phosphor layer with respect to 100 [wt %] of phosphor particles. The phosphor layer will have insufficient strength if too little metal oxide is obtained from the reaction with the metal compound, and luminance will be insufficient if there is too much of the metal oxide. Adding an amount of the metal compound such that the metal oxide makes up approximately 0.1 [wt %] to 0.6 [wt %] with respect to 100 [wt %] of the phosphor particles makes it possible to obtain a phosphor layer that achieves both strength and luminance. While there are no particular restrictions, it is suitable for the amount of the solvent to be, for example, approximately 45 [wt %] to 120 [wt %] with respect to 100 [wt %] of phosphor particles.

The coating material may include a binding agent, thickening agent, or the like as necessary. The binding agent is, for example, a phosphorous or boron binding agent, and the thickening agent is nitrocellulose or the like. In this case, it is suitable for the amount of the added binding agent to be approximately 0.1 [wt %] to 2 [wt %] with respect to 100 [wt %] of phosphor particles, and for the amount of added thickening agent to be approximately 0.3 [wt %] to 2.5 [wt %] with respect to 100 [wt %] of phosphor particles.

Next, the coating material is applied to the inner side of the glass tube. Application of the coating material to the glass tube is performed using a method of, for example, sucking a liquid up the glass tube which has been stood upright. While there are no particular restrictions, the amount of coating material to be applied is adjusted such that the phosphor layer includes, for example, 2 [mg/cm²] to 5 [mg/cm²] of phosphors.

Next, organic solvents included in the applied coating material are vaporized, and the coating layer is dried. At this time, a concentration of the metal compound in the coating material rises (the metal compound solution becomes concentrated) as the solvents in the coating material vaporize, and before long, the metal compound is deposited between the phosphor particles. With the progression of the vaporization, the solution moves to narrower gaps between the phosphor particles due to surface tension. This results in the metal compound being deposited disproportionately in portions where the inter-phosphor particle distance is narrow.

Here, since vaporization is performed quickly in the conventional case of using a single type of organic solvent, it is speculated that vaporization finishes before the solvent moves into narrow spaces between the phosphor particles. As a result, it is speculated that the metal oxide bodies formed between the phosphor particles will ultimately be clump-shaped.

In contrast, in the case of using solvents with two different boiling points, vaporization progresses gradually beginning with the solvent that most readily vaporizes. In other words, the vaporization of one solvent will complete before the vaporization of another. As a result, it is speculated that the metal oxide bodies will ultimately be rod-shaped bodies spanning between the phosphor particles due to the solvents sufficiently moving into narrow spaces therebetween.

Drying of the coating material is performed, for example, while the glass tube 204 is stood upright, that is, without changing the position of the glass tube 204 after the coating material has been applied. Drying may also be performed while rotating the upright glass tube 204.

Drying of the coating material may be performed by maintaining an atmosphere in the glass tube 204 in which the solvent readily vaporizes. For example, a gas need only be continuously supplied into the glass tube 204. While there are no particular restrictions on the amount of gas to be supplied, productivity falls if too little gas is supplied, and supplying too much gas inhibits the formation of a highly uniform phosphor layer. It is therefore suitable for the gas supply rate to be more than 0 [ml/min/cm²] and up to 64 [ml/min/cm²], and more preferably 16 [ml/min/cm²] to 48 [ml/min/cm²]. Note that it is not necessary for the solvent to be completely removed. A small amount of the solvent may remain.

As is shown in working example 2 which is mentioned hereinafter, it is preferable to supply a gas with a humidity of 10[%] to 40[%] at 25 [° C.] into the glass tube 204 while drying the coating material. It is unclear why, but uniformity of the thickness etc. of the phosphor layer 202 deteriorates if the humidity in the glass tube is too low.

Specifically, gaps form in the phosphor layer 202 as if slippage occurred during drying of the coating material, and this causes unevenness in the phosphor layer 202. On the other hand, vaporization of the solvents takes too long if the humidity is too high, thereby reducing production efficiency. Supplying the above gas in the glass tube 204 while vaporizing the solvents enables the efficient formation of the phosphor layer 202 with excellent uniformity of thickness and the like. It is also possible to provide the fluorescent lamp 100 which has little luminance variation, by improving the uniformity of the phosphor layer 202.

Next, the dried coating material is baked. A sinter furnace, electric furnace, or the like may be used to raise an internal temperature of the glass tube 204 to approximately 600 [° C.] to 700 [° C.].

Next, the interior of the glass tube 204 is evacuated, mercury and rare gases are filled therein, and both ends of the glass tube are sealed, as is normally performed, thereby obtaining the glass tube 204

The metal compound included in the coating material can be, for example, an organic metal compound such as yttrium carboxylate (Y(CₙH₂ₙ₊₁COO)₃, 5=n=8), yttrium isopropoxide (Y(OC₃H₇)₃), tetraethoxysilane (Si(OC₂H₅)₄), etc., or a metal nitrate, a metal sulfate, a metal carboxylate, a metal beta-diketonate complex, or the like.

The following describes a reaction in which a metal compound becomes a metal oxide, taking an example in which yttrium caprylate (Y(C₇H₁₅COO)₃) is used as the metal compound.

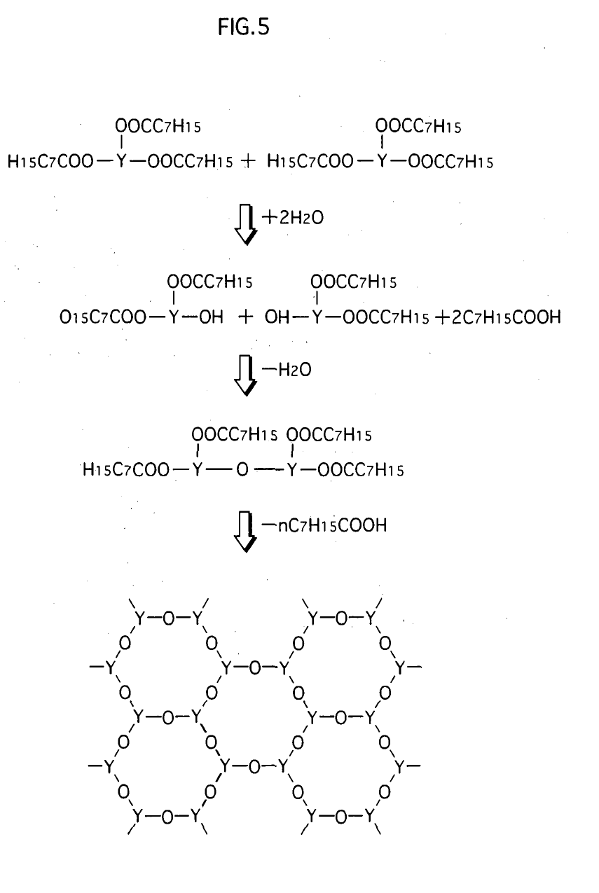

As shown in FIG. 5, in the yttrium caprylate, the caprylate group (—OOCC₇H₁₅) is replaced by the hydroxide group (—OH) due to hydrolysis, and C₇H₁₅COOH is simultaneously produced. The resultant yttrium compound is dehydrated to cause polymerization. After this reaction has been repeated, the polymer is baked and annealed. This is how yttrium caprylate becomes yttrium oxide (Y₂O₃).

Note that, for example, the ratio etc. of the metal compound included in the coating material for formation of the phosphor layer need only be adjusted in order to keep the phosphor particles 202a from being exposed on the face of the phosphor layer 202 on the discharge space side, as shown in FIG. 3. Alternatively, in addition to the coating material for formation of the phosphor layer, there may be provided another coating material that contains the above metal compound but does not include phosphor particles, and the phosphor layer may be formed by applying the latter coating material after drying the former coating material but before baking. A formation method of the metal oxide layer 205 is the same. The latter metal compound-containing coating material includes, for example, the components of the coating material for formation of the phosphor layer, with the exception of phosphor particles.

### Embodiment 3

Next is a description of an exemplary lighting device including an exemplary fluorescent lamp of the present invention. The following describes an example of a backlight unit included in a liquid crystal display (LCD) apparatus, as the exemplary lighting device. However, the present invention is not limited to this, and may be used in any known display device that requires a lighting device. Also, although the following describes a direct-type backlight unit in which a plurality of fluorescent lamps are arranged in parallel on aback face of an LCD panel, the lighting device of the present embodiment may be an edge-light backlight unit in which a fluorescent lamp is disposed on an edge surface of a light guide plate mounted to the back face of the LCD panel.

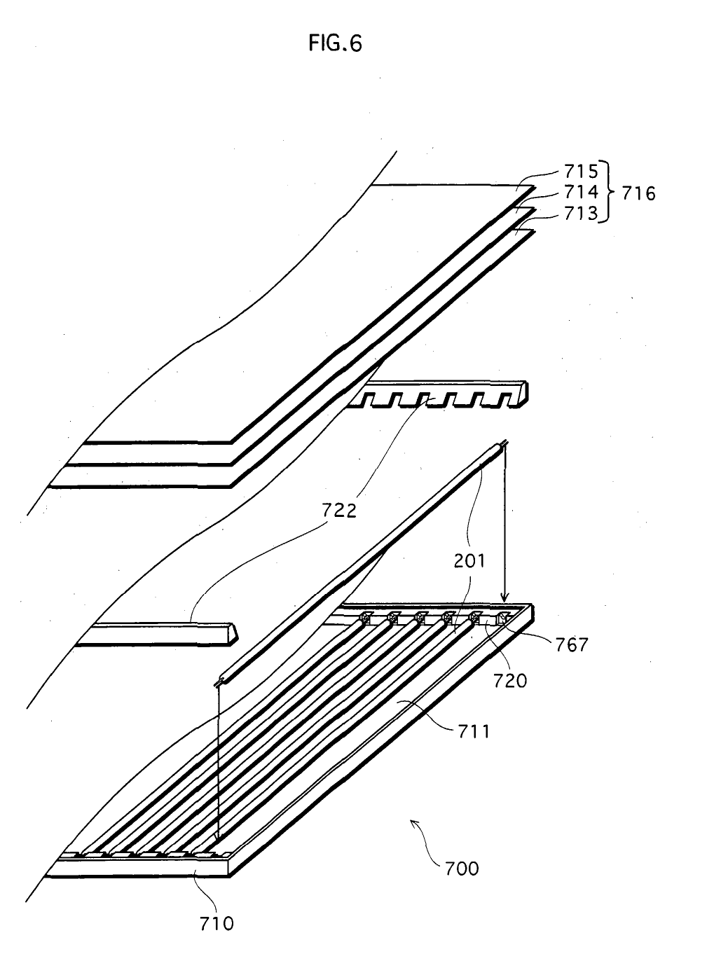

FIG. 6 is an exploded perspective view showing an outline of a structure of a backlight unit 700 pertaining to the present embodiment.

The direct-type backlight unit 700 includes a plurality of cold-cathode fluorescent lamps 201, a housing 710 for storing the fluorescent lamps 201 and which is open on the liquid crystal panel side for extracting light, and an optical sheet 716 that covers the opening of the housing 710.

A plurality (e.g., 14) of the fluorescent lamps 201 are disposed in the housing 710 such that an axis of the fluorescent lamps 201 in the longitudinal direction is substantially uniform with an axis of the housing 710 in the length (horizontal) direction. The fluorescent lamps 201 are disposed with a predetermined space therebetween in a latitudinal (vertical) direction of the housing 710.

The fluorescent lamps 710 are operated using a lighting device not depicted.

The housing 710 is made from polyethylene terephthalate (PET) resin, and a metal such as silver has been vapor deposited on an inner side of the housing 710 to form a reflective surface 711. Note that the housing 710 may be constituted from, for example, a metallic material such as aluminum or a cold-rolled strip (e.g., SPCC), instead of a resin.

Note that instead of providing the reflective surface 711, a reflective sheet, which is formed from polyethylene terphthalate (PET) resin to which calcium carbide, titanium dioxide or the like has been added to raise a reflectivity thereof, may be adhered to the housing 710.

Also, as shown in FIG. 6, sets of sockets 767 are provided in the housing 710 at positions corresponding to mounting positions of the fluorescent lamps 201. The sockets 767 are conductive, and are formed by bending, for example, a stainless or phosphor-bronze plate. A groove conforming to an outer diameter of the lead wires is formed in an upper portion of each of the sockets 767, the fluorescent lamps 201 are electrically connected by fitting the lead wires into the grooves.

The sockets 767 are covered by an insulating material 720 such that an electrical short does not occur between neighboring sockets. The insulating material 720 is constituted from, for example, polyethylene terephthalate (PET). Note that the insulating material 720 is not limited to the above constitution. It is preferable for, the insulating material 720 to be constituted from a heat-resistant material since the sockets 767 are in a vicinity of the electrodes 206 (shown in FIG. 1) which become relatively hot during operation of the fluorescent lamps 201. The heat-resistant material can be, for example, polycarbonate (PC) resin or silicon rubber.

The sockets 767 are covered by covers 722. The covers 722 separate the sockets 767 and the space inside the housing 710, and are composed of, for example, polycarbonate resin. The covers 722 retain heat around the sockets 767. A reduction in luminance at ends of the fluorescent lamps 201 can be mitigated by making at least a surface on the housing 710 side of the covers 722 highly reflective.

The opening of the housing 710 is covered by the translucent optical sheet 716, and is hermitically sealed such that foreign substances such as dust and dirt cannot enter the housing 710. The optical sheet 716 is formed by laminating a diffusion plate 713, a diffusion sheet 714, and a lens sheet 715. The diffusion plate 713 is a plate-shaped material composed of polymethyl methacrylate (PMMA) resin, and is disposed so as to block the opening of the housing 710. The diffusion sheet 714 is composed of, for example, polyester resin.

The diffusion plate 713 and the diffusion sheet 714 scatter and diffuse light emitted from the cold-cathode fluorescent lamps 201, and the lens sheet 715 aligns the light in a normal direction of the sheet 715. As a result, the light emitted from the cold-cathode fluorescent lamps 201 radiates evenly across and entirety of a surface (light emitting surface) of the optical sheet 716.

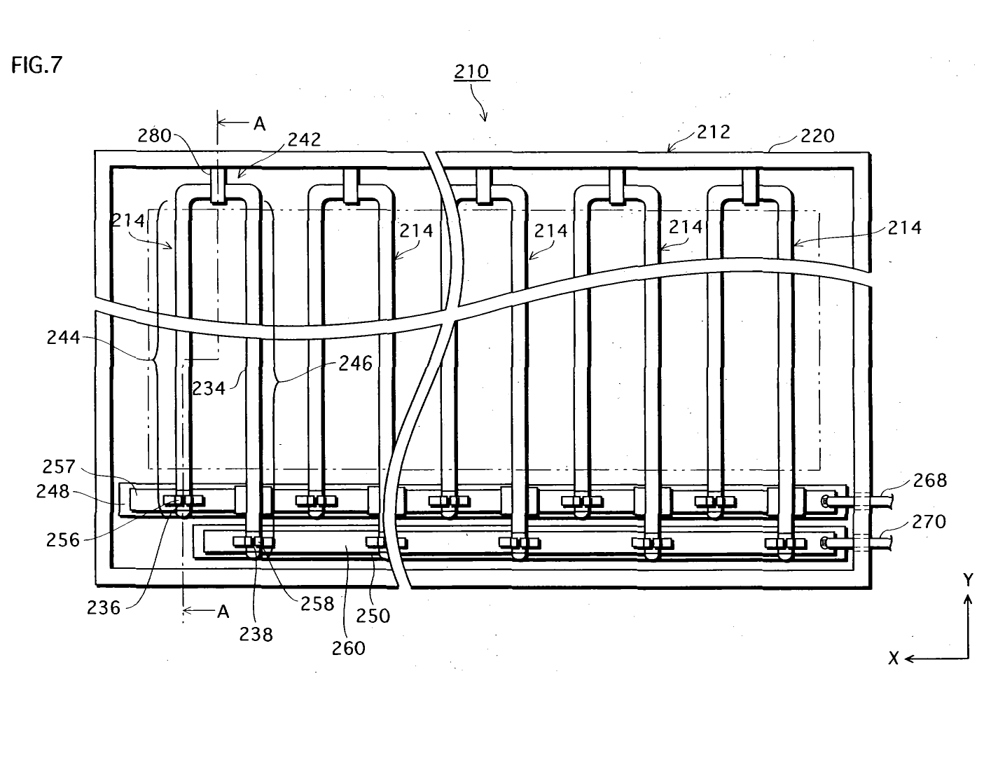

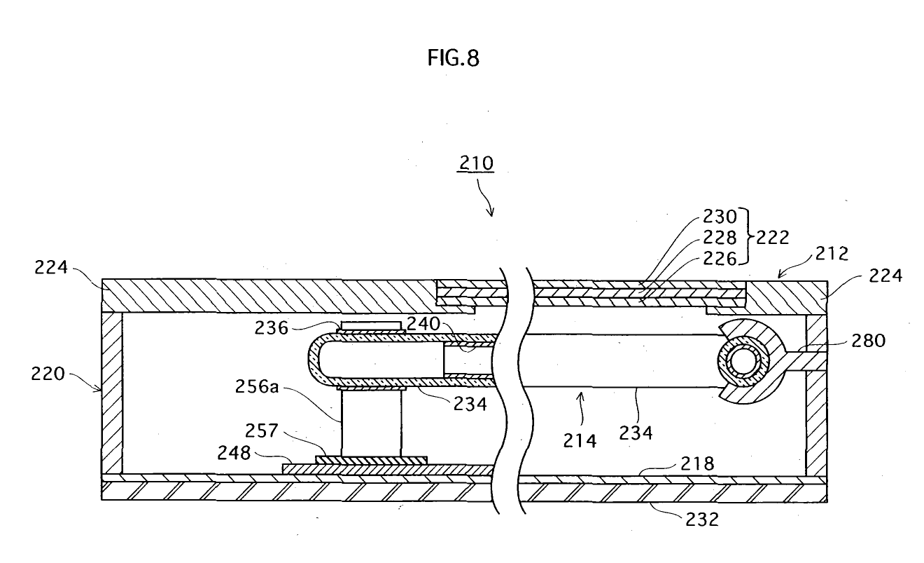

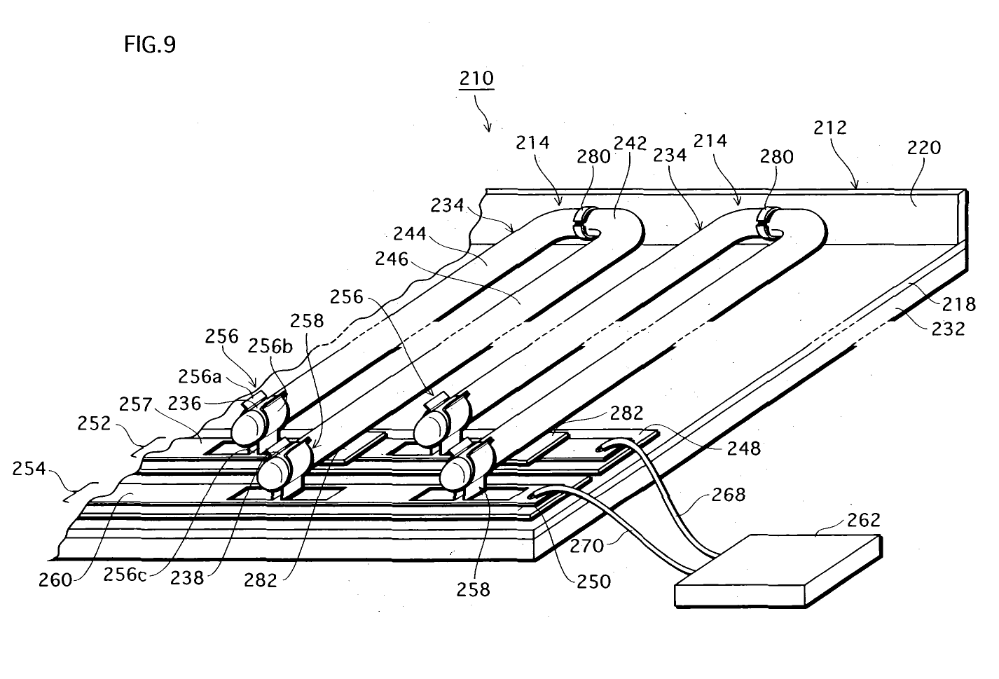

FIG. 7 is a plan view showing a schematic structure of a backlight unit 210 of the present embodiment, FIG. 8 is an enlarged cross-sectional view taken along A-A of FIG. 7, and FIG. 9 is a perspective view of the backlight unit 210 of the present embodiment. Note that FIGS. 7 and 9 show the backlight unit 210 in a state in which the optical sheet 716 shown in FIG. 8, a mounting frame 224 for mounting the optical sheet 716, and the like have been excluded. Also, the scale between constituent elements is not the same in FIGS. 7, 8, and 9. Note that descriptions of structures substantially the same as in FIG. 6 have been omitted.

As shown in FIGS. 7 and 8, the backlight unit 210 includes a casing 212 which stores a plurality of exemplary fluorescent lamps 214 of the present invention. The fluorescent lamps 214 are U-shaped curved external electrode fluorescent lamps (EEFLs).

The casing 212 includes, for example, a reflecting plate 218, side walls 220 that are vertically arranged on a periphery of the reflecting plate 218, a mounting frame 224 that is mounted to the side walls 220 in opposition to the reflecting plate 218, and the optical sheet 716. The optical sheet 716 is mounted in the mounting frame 224, and is disposed parallel to the reflecting plate 218. Given that the mounting frame 224 is formed from a non-light transmitting material, light generated from the fluorescent lamps 214 is emitted from an area enclosed by a dashed double-dotted line in FIG. 7 where the optical sheet 716 is. In other words, the optical sheet 716 functions as a window able to transmit light emitted by the fluorescent lamps 214.

The fluorescent lamps 214 are dielectric barrier discharge fluorescent lamps which are provided with external electrodes 236 and 238 around an outer circumference of end portions of glass tubes 234, and use the glass tube walls as capacitors. The external electrodes 236 and 238 are formed by, for example, winding a metal foil such as aluminum foil or copper foil around the outer circumference of the glass tubes 234, vapor depositing metal on a surface of the glass tubes 234, or applying a conductive paste and baking.

A phosphor layer 240 is formed on an inner side of each of the glass tubes 234. However, the phosphor layer 240 is not formed on portions of the inner side where the glass tube 234 contacts the external electrodes 236 and 238, in order to suppress a significant depletion of the mercury enclosed in the glass tube 234. Materials of the phosphor layer 240 and a formation method thereof are the same as in the case of the cold-cathode fluorescent lamp 100 of embodiment 1. Mercury (not depicted) is added into the glass tube 234, and a mixed gas (not depicted) including neon and argon is enclosed as a discharge material (discharge gas).

Each of the glass tubes 234 has a U-shaped curved part 242, and a first straight part 244 and a second straight part 246 which are arranged extending parallel out from the curved part 242. The second straight part 246 is made longer than the first straight part 244, in order to reach a position where a hereinafter-mentioned second connector 258 is disposed.

As shown in FIG. 9, two elongated insulating plates (a first insulating plate 248 and a second insulating plate 250) are laid substantially parallel on a top surface of the reflecting plate 218. The first and second insulating plates 248 and 250 are composed of, for example, polycarbonate. Note that, alternatively, in the present example, a single insulating plate with an area that is about the same as a total area of the first and second insulating plates 248 and 250 may be used. A top surface of the first insulating plate 248 is provided with a first feeder 252 for supplying power to the first external electrode 236, and a top surface of the second insulating plate 250 is provided with a second feeder 254 for supplying power to the second external electrode 238.

The first feeder 252 is composed of a plurality of first connectors 256, and a first plate 257 that physically links and electrically connects the first connectors 256. The number of first connectors 256 corresponds to the number of fluorescent lamps 214. The first plate 257 is attached to the top surface of the first insulating plate 248. An external electrode 236 (hereinafter, may be called a “first external electrode 236” for distinction from the external electrode 238) is fitted into each of the first connectors 256. The first connectors 256 include clamp pieces 256a and 256b, and a plate-shaped part (link 256c) that links the clamp pieces 256a and 256b. A remaining portion of plate-shaped part not included the first connector 256 constitutes the first plate 257. The clamp pieces 256a and 256b can be formed by, for example, performing the following process on an elongated plate material composed of a conductive material such as phosphor bronze or the like. The plate material is scored so as to leave one adjoining side of two consecutive rectangles in the longitudinal direction. A pair of cantilever pieces formed in this way are folded to be substantially perpendicular to the plate material, and an end of each of the cantilever pieces is given a shape that conforms to the outer circumference of the fluorescent lamps. The clamp pieces 256a and 256b bend outward when the first electrode 236 is fitted into the first connector 256, and the first electrode 236 is held in the first connector 256 due to the restoring force of the clamp pieces 256a and 256b.

Similarly, the second feeder 254 is composed of a plurality of second connectors 258, and a second plate 260 that physically links and electrically connects the second connectors 258.

Areas of the first plate 257 that pass under the second straight parts 246 of the glass tubes 234 are covered by insulating sheets 282. The insulating sheets 282 are composed of an insulating material such as polycarbonate or the like.

In the example shown in FIG. 9, portions of the second straight parts 246 that are closer to the second external electrodes 238 pass over the first plate 257 which is electrically connected to the first external electrodes 236. There is therefore a large difference in electrical potential where the second straight parts 246 and the first plate 257 intersect. Consequently, leakage current will flow from the higher potential area to the lower potential area where the second straight parts 246 and the first plate 257 intersect, if the insulating sheets 282 are not provided, and this becomes a cause for luminance reduction in the fluorescent lamps 214. It is therefore preferable to arrange the insulating sheets 282 at the points of intersection to suppress the leakage of current as much as is possible.

The backlight unit 210 includes an inverter 262 which is electrically connected to the first plate 257 and the second plate 260 via lead wires 268 and 270. The inverter 262, which is a power supply circuit unit, converts 50/60 Hz AC power from a commercial power supply (not depicted) into high-frequency power, and supplies the high-frequency power to the fluorescent lamps 214. Thus, power is supplied over 2 conductive lines to the fluorescent lamps 214 via the first plate 257 and the second plate 260, and it is possible to operate the plurality of fluorescent lamps 214 in parallel using the one inverter 262.

Curved support members 280 having “C” shaped parts are mounted to one of the side walls 220 in correspondence with the fluorescent lamps 214. The curved support members 280 are composed of, for example, a resin such as polyethylene terephthalate (PET) or the like. Mounting the fluorescent lamps 214 into the casing 212 is simple since it is only necessary to fit the curved parts 242 of the glass tubes 234 into the “C” shaped parts, then fit the first and second external electrodes 236 and 238 that are formed around an outer circumference of the ends of the glass tubes 234 into the first and second connectors 256 and 258 respectively.

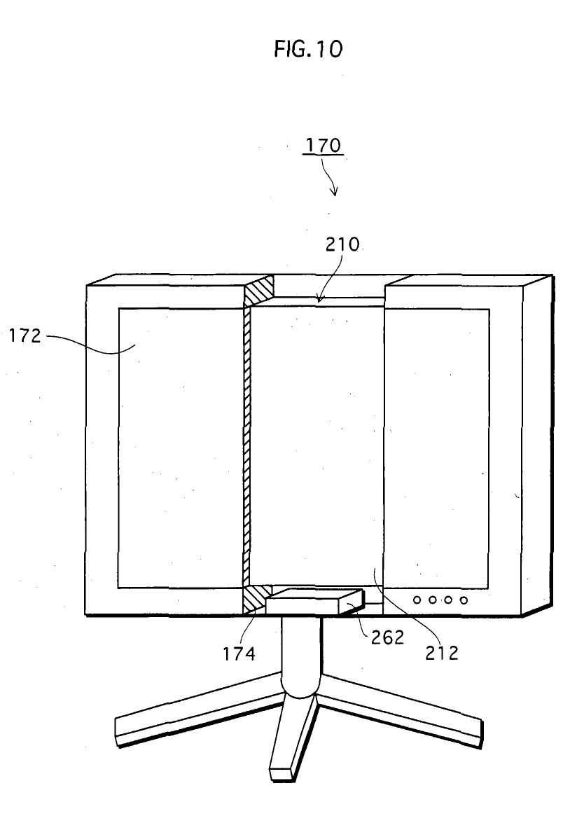

FIG. 10 shows an exemplary liquid crystal television as an example of a display apparatus using the backlight unit 210 of the embodiments. In FIG. 10, a portion of a front surface of a liquid crystal television 170 has been cut away for convenience in the description. The liquid crystal television 170 is, for example, a 32-[inch] liquid crystal television, and includes a liquid crystal display panel (LCD) 172 etc. in addition to the backlight unit 210. The LCD panel 172 is composed of a color filter substrate, a liquid crystal, a TFT substrate etc., and is driven by a drive module (not depicted) to form color images based on an external image signal.

The casing 212 of the backlight unit 210 is disposed on a back face side of the LCD panel 172, and the backlight unit 210 radiates light from the back face to the LCD panel 172. The inverter 262 is disposed outside the casing 212, such as, for example, in a housing 174 of the liquid crystal television 170.

The following more specifically describes examples of the present invention using working examples. Note that the present invention is not limited to the following working examples.

### First Working Example

In the first working example, a cold-cathode fluorescent lamp with the structure shown in FIG. 1 was made in the following way. First, there were provided (Y₂O₃:Eu³⁺), (LaPO₄:Tb³⁺, Ce³⁺), and (BaMg₂Al₁₆O₂₇:Eu²⁺) as three-wavelength phosphors. A mixture ratio of these three phosphors was adjusted such that a color temperature would be 10,000 [K]. 1 [kg] of the three-wavelength phosphors was dispersed in a mixed solvent composed of butyl acetate and turpentine to obtain a suspension. Before dispersal of the phosphors, 15 [g] of NC (nitrocellulose) and 1.5 [g] of a boric acid binding agent were dissolved in the mixed solvent. A mixture ratio of the butyl acetate and turpentine in the mixed solvent was 900 [g] of butyl acetate to 4 [g] of turpentine. Yttrium caprylate was added to the suspension and dissolved by stirring, thereby obtaining a coating material for formation of the phosphor layer. 15 [g] of yttrium caprylate was added for 1 [kg] of phosphor particles.

Next, the coating material was applied to an inner side of a glass tube having an outer diameter of 2.4 [mm], a length of 400 [mm], and a wall-thickness of 0.2 [mm]. Application of the coating material to the glass tube was performed using a method of sucking a liquid up the upright glass tube. A composition of the glass tube was as follows.

SiO₂: 69.3[%]

Al₂O₃: 5.1[%]

B₂O₃: 15.5[%]

Li₂O: 0.48[%]

Na₂: 1.4[%]

K₂O: 4.8[%]

MgO: 0.5[%]

CaO: 0.9[%]

SrO: 0.04[%]

BaO: 1.2[%]

Sb₂O₃: 0.1[%]

As₂O₃: 0[%]

TiO₂: 0.6[%]

ZrO₂: 0.1[%]

Next, air with a relative humidity of 12[%] at 25 [° C.] was supplied into the glass tube for approximately eight minutes to dry a layer composed of the applied coating material. This drying of the layer was performed while rotating the upright glass tube. The warm air was supplied at a rate of 30 [ml/min/cm²]. Then baking was performed using an electric furnace set to 670 [° C.]. The baking time was ten minutes. At this time, the temperature inside the glass tube reached 650 [° C.] when measured using a thermocouple.

Next, the interior of the glass tube was evacuated, gases (Ne:Ar=95:5, at approximately 8 [kpa]) and 3 [mg] of mercury were enclosed therein, and the glass tube was sealed, thereby obtaining a fluorescent lamp (a).

Note that Nb was used in the material of the electrodes. The electrodes had a length N in the axial direction of 5.5 [mm], an inner diameter of 1.7 [mm], and a wall-thickness of 0.1 [mm]. A distance M from an end surface of the glass tube to the electrode 6 is 8.2 [mm]. Cs₂AlO₃ was used in the emitter.

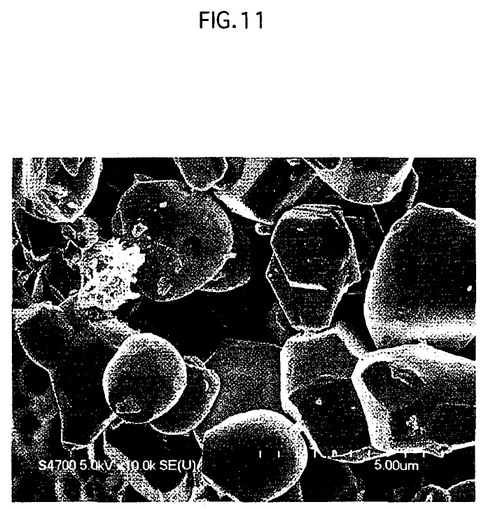

Upon observing a 300 [μm] square area of the phosphor layer using an HRSEM, it was apparent that the phosphor particles were spanned by rod-shaped metal oxide bodies (rod-shaped bodies) with a thickness of 0.2 [μm] to 1.5 [μm]. In some portions, pairs of phosphor particles were spanned by a plurality of the rod-shaped bodies. The rod-shaped bodies had an average thickness of 0.5 [μm]. FIG. 11 shows an HRSEM photograph of the phosphor layer.

Note that the “average thickness” of the rod-shaped bodies is an arithmetic average value of thicknesses measured at ½ of the longitudinal length of the plurality of rod-shaped bodies in the 300 [μm] square area of the phosphor layer that was observed using the HRSEM.

Upon measuring the luminance of the lamp using a spectroradiometer (made by TOPCON, Model No. SR-3), the initial luminance was 36,835 [cd/m²]. Assuming the initial luminance is 100[%], a luminance maintenance rate was 90[%] at 2,000 hours of operation. Note that the operation frequency and the lamp current were kept constant at 55 [kHz] and 6 [mA].

### Comparative Example 1

A fluorescent lamp (b) was made in the same way as in the first working example, except for using only butyl acetate as the solvent constituting the coating material for formation of the phosphor layer.

Similarly to the first working example, upon observing the phosphor layer using an HRSEM, it was apparent that the phosphor particles were spanned by clumps of metal oxide. The clumps had a thickness of 2 [μm] or more. The initial luminance was 34,260 [cd/m²], and the luminance maintenance rate was 92[%] at 2,000 hours of operation. Here, the “thickness” of the clumps was a thickness at ½ of the length between the phosphor particles spanned by the clumps.

As mentioned above, the luminance maintenance rates of the fluorescent lamps (a) and (b) at 2,000 hours of operation were 90[%] or more, which is high. This confirmed that the fluorescent lamps (a) and (b) have a substantially equal mercury-barrier effect. On comparison, the luminance maintenance rate of the fluorescent lamp (a) was 2[%] lower than that of the fluorescent lamp (b), but the initial luminance of the fluorescent lamp (a) was approximately 7[%] higher than that of the fluorescent lamp (b). According to this, the fluorescent lamp (a) ensured high luminance while suppressing the consumption of mercury more than the fluorescent lamp (b).

### Second Working Example

In the second working example, fluorescent lamps (c) to (g) were made in the same way as in the first working example, except for changing the temperature of the gas supplied into the glass tube while drying the coating layer.

Gases with humidities of 40[%], 15[%], 10[%], 8[%] and 5[%] at 25 [° C.] were used for the fluorescent lamps (c) to (g) respectively. In the present invention, the humidity in the glass tubes was therefore kept at 40[%], 15[%], 10[%], 8[%] and 5[%] while the gas was being supplied.

Uniformity of the thicknesses of the phosphors layers was examined for the fluorescent lamps (c) to (g). First, an HRSEM was used to observe the phosphor layer over an entire length in the longitudinal direction of each of the fluorescent lamps. A larger variation in thickness of the phosphor layer was observed in the fluorescent lamps (g) and (f), in which the coating material was dried using a gas with a humidity of less than 10[%] at 25 [° C.], compared with the fluorescent lamps (c) to (e) in which the coating material was dried using a gas with a humidity of 10[%] to 40[%] at 25 [° C.]. Specifically, unevenness was observed in the phosphor layers of the fluorescent lamps (g) and (f) due to gaps appearing in the phosphors layers as though the coating material slipped during drying. On the other hand, the thicknesses of the phosphor layers of the fluorescent lamps (c) to (e) were substantially constant (18 [μm] plus or minus 2 [μm]) over the entire length in the longitudinal direction.

Next, the HRSEM was used to observe contact points between the phosphor layer and the glass tube at a predetermined site. The predetermined site was a site 1 [mm] directly above one of the edges of the phosphor layer, and the one edge is that which was disposed upward during application of the coating material. A large number of contact points (per mm) at this site means that the extent of slippage of the coating material was small, and there is a good uniformity of thickness etc. of the phosphor layer.

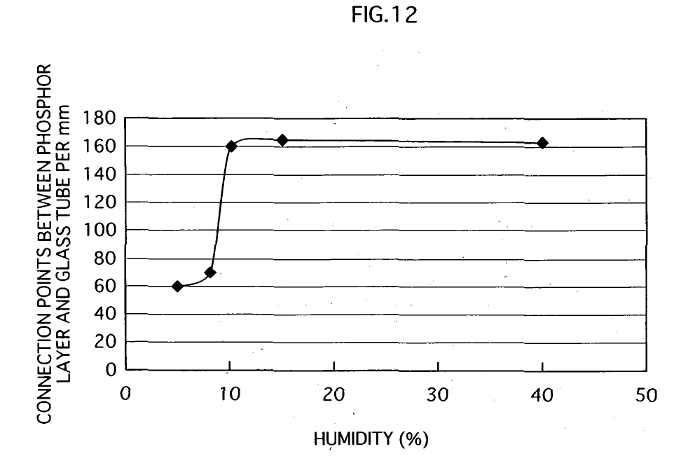

FIG. 12 shows a relationship between humidity inside the glass tube and the number of contact points. There are 163 contact points at a humidity of 40[%], 165 at a humidity of 15[%], 160 at a humidity of 10[%], 70 at a humidity of 8[%], and 60 at a humidity of 5[%]. It was confirmed from these results that it is possible to form a phosphor layer with excellent uniformity of thickness when a gas with a humidity of 10[%] to 40[%] at 25 [° C.] is supplied into the glass tube while vaporization of the solvent is performed in the phosphor formation step.

### Embodiment 4

A display apparatus such as a liquid crystal display apparatus includes a fluorescent lamp unit connected to a drive circuit. A phosphor layer is formed on an inner side of a lamp container of each of the fluorescent lamps in the fluorescent lamp unit, and mercury is enclosed in the lamp container. When excited, the mercury emits ultraviolet radiation which causes the phosphor layer to emit visible light, whereby the fluorescent lamp unit functions as an illumination source for the display apparatus.

However, the phosphor layer degrades with use of the fluorescent lamp due to the adsorption of mercury. As a result of this adsorption of mercury, it gradually becomes difficult for phosphor particles in the phosphor layer to favorably realize their function of emitting light, the luminance of the fluorescent lamp degrades, and furthermore, the fluorescent lamp reaches the end of its life.

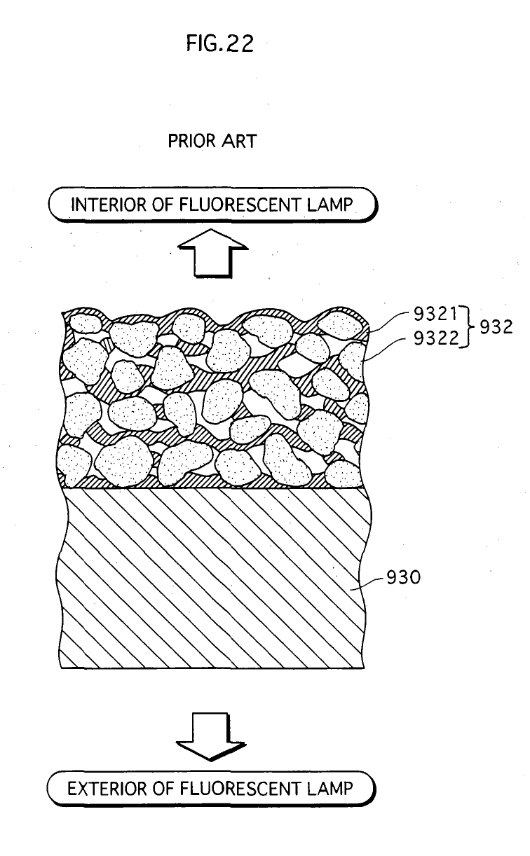

A protective layer is therefore provided on the phosphor layer to protect the phosphor particles from the mercury adsorption, which suppresses the reduction in luminance and lengthens the life of the fluorescent lamp. One proposed method for accomplishing this involves, as shown in the phosphor particle pattern diagram of FIG. 22, forming a protective layer composed of a metal oxide by covering and interconnecting the phosphor particles, which constitute the phosphor layer, with spanning structures in order to control the adsorption of mercury and maintain a predetermined emission luminance (e.g., Japanese Patent Application Publication No. 2002-164018).

However, although using the protective layer disclosed in Japanese Patent Application Publication No. 2002-164018 makes it possible to suppress the adsorption of mercury to the phosphor particles, mercury adsorption is not completely prevented, and there is still room for improvement. Therefore, a method such as increasing the thickness of the protective film improves the effects of suppressing mercury adsorption and the degradation of the phosphor particles. On the other hand, such a method is not desirable since the thickening of the protective layer causes light emitted from the phosphor layer to be blocked, whereby the emission luminance in reduced.

Also, given that the adsorption of mercury differs according to the phosphor particle material, phosphor particles to which mercury readily adsorbs have a greater rate of degredation over time than other phosphor particles, which not only reduces emission luminance, but also largely affects the color balance.

Therefore an aim of the present embodiment and the later-mentioned embodiment 5 is to provide a fluorescent lamp that maintains a predetermined initial emission luminance while suppressing the degredation of emission luminance and the influence on the color balance, and that can realize a long life.

First, the following describes a cold cathode fluorescent lamp 20 pertaining to embodiment 4.

4.1 Structure of the Cold Cathode Fluorescent Lamp 20

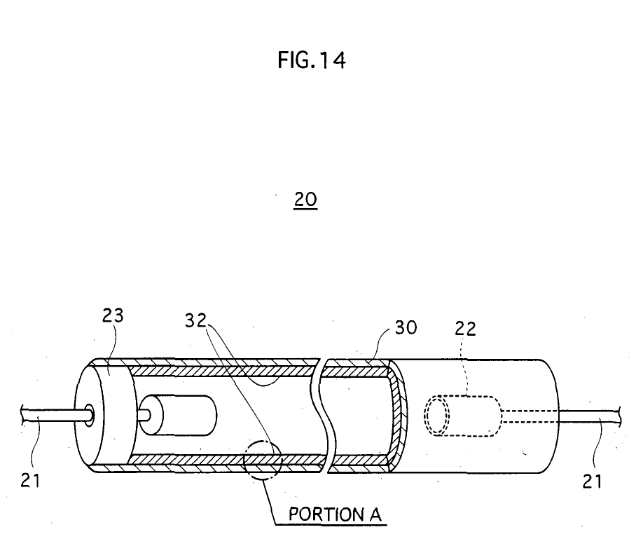

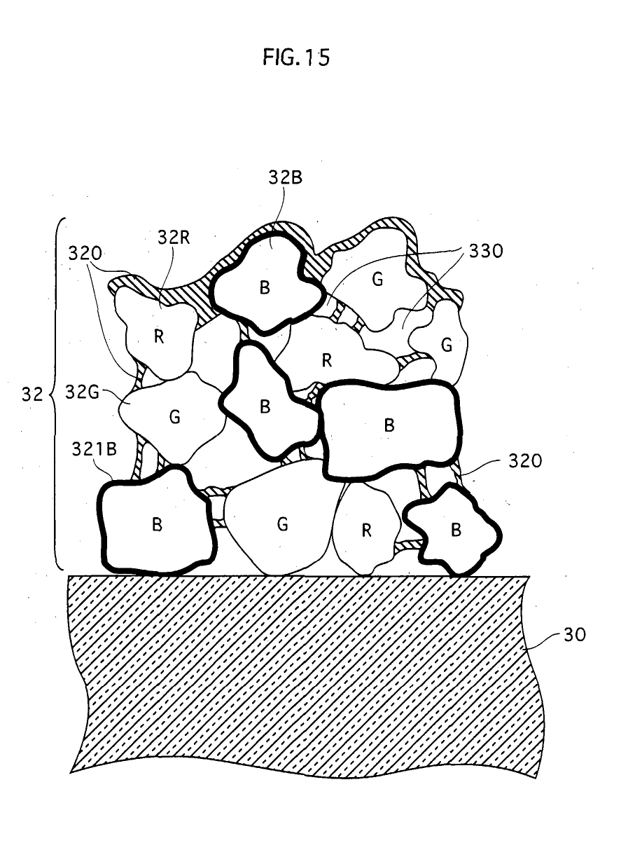

FIG. 14 is a partially cut-out perspective view showing an outline of a structure of the cold cathode fluorescent lamp 20, and FIG. 15 is an expanded view of a portion A in FIG. 14.

The cold cathode fluorescent lamp 20 is constituted from a glass tube 30 as a glass container having a phosphor layer 32 disposed on an inner side thereof, lead wires 21 passing through bead glass 23, and electrodes 22 to which ends of the lead wires 21 are affixed. Note that mercury and rare gases are enclosed in the glass tube 30.

The glass tube 30 has a substantially circular cross section cut vertically with respect to the tube axis, and is composed of, for example, borosilicate glass. Note that the glass tube 30 has a length of 720 [mm], an outer diameter of 3 [mm], and an inner diameter of 2 [mm].

The lead wires 21 are affixed to ends of the glass tube via the bead glass 23. The lead wires 21 are continuous wires composed of, for example, an inner lead wire formed from tungsten (W), and an outer lead wire formed from nickel (Ni). Note that the interior of the glass tube 30 is hermetically sealed as a result of the bead glass 23 and the glass tube 30 being fused together, and the bead glass 23 and the lead wires 21 being affixed by frit glass. Also, the electrodes 22 and the lead wires 21 are affixed using, for example, laser welding.

The electrodes 22 are so-called hollow electrodes which are cylindrical and have a bottom. Here, using a hollow electrode is effective in suppressing sputtering at the electrode that occurs due to discharges during operation.

The mercury is enclosed in the glass tube 30 at a predetermined amount per volume of the glass tube 30, such as 0.6 [mg/cc]. Also, the rare gases include an argon-neon mixed gas (5[%] argon, 95[%] neon) that is enclosed in the glass tube 30 at a predetermined pressure of, for example, 60 [Torr].

4.2 Structure of the Phosphor Layer 32

FIG. 15 is an enlarged outline view of the portion A in FIG. 14. As shown in FIG. 15, the phosphor layer 32 is composed of blue phosphor particles 32B, green phosphor particles 32G, and red phosphor particles 32R (noted as B, G, and R respectively in FIG. 15). The blue, green, and red phosphor particles 32B, 32G, and 32R convert ultraviolet radiation emitted by the mercury into blue, green, and red light respectively.

In the present embodiment, BaMg₂Al₁₆O₂₇:Eu²⁺ (BAM, Eu-activated barium magnesium aluminate) is used as the blue phosphor particles 32B, LaPO₄:Tb³⁺ (LAP, Tb-activated lanthanum phosphate) is used as the green phosphor particles 32G, and Y₂O₃:Eu³⁺ (YOX, Eu-activated yttrium oxide) is used as the red phosphor particles 32R.

As shown in the enlarged view of FIG. 15, the phosphor layer 32 is provided with general coating films 320 (hereinafter, called a “first protective film”) that cover a surface of the phosphor layer 32 as well as link the phosphor particles, and individual coating films 321B (hereinafter, called “second protective films”) that coat the blue phosphor particles 32B.

The first protective films 320 are composed of vitrified and chemically stabilized yttrium oxide Y₂O₃, which is a rare earth oxide, and in addition to covering the surface of the phosphor layer 32, have a network-like or mesh-like structure that fills spaces between the phosphor particles 32B, 32G, and 32R. Portions of the first protective films 320 inside the phosphor layer 32 are, as shown in FIG. 15, in the form of rod-shaped bodies similarly to embodiment 1. According to this structure, the phosphor layer 32 is provided so as to separate the glass tube 30 from the interior thereof, and such that the mercury cannot penetrate into the phosphor layer 30 or reach the glass tube 30. The first protective films 320 have the aforementioned structure, which more specifically and as shown in FIG. 15, includes spaces 330 formed between the phosphor particles 32B, 32G, and 32R, and the first protective films 320 cover portions of the phosphor particles 32B, 32B, and 32R (note that the blue phosphor particles 32B are coated by the protective films 321B mentioned hereafter). Note that the first protective films 320 uniformly compose 0.3 [wt %] of a total weight composition of the phosphor particles 32B, 32G, and 32R.

The second protective films 321B are composed of lanthanum oxide La₂O₃ (hereinafter, may be noted as simply “La”), which is a rare earth oxide, and coat the blue phosphor particles 32B so as to encompass them. The second protective films 321B cover surfaces of the blue phosphor particles 32B, and compose 0.6 [wt %] of a total weight composition of the blue phosphor particles 32B. Note that the aforementioned first protective films 320 are formed on top of the second protective films 321B. In this way, the second protective films 321B are formed on specifically the blue phosphor particles 32B to give them a commensurately thicker coating than the other phosphor particles 32G and 32R.

The inventors of the present invention have confirmed the presence of the first and second protective films 320 and 321B using an analysis apparatus such as an SEM (scanning electron microscope) or an XMA (X-ray microanalyzer).

4.3 Formation Method for the Phosphor Layer 32

Next is a description of a formation method for the phosphor layer 32. The present method involves performing (A) a phosphor particle material preparation step, (B) a phosphor particle application step, (C) a metal alkoxide processing step, and (D) a heat processing step in order.

First, a phosphor particle material such as a three-wavelength luminous body material is prepared in the phosphor particle material preparation step. Here, the aforementioned second protective films 321B are assumed to have been formed on the blue phosphor particles 32B. A method for forming the second protective films 321b involves, for example, dispersing the blue phosphor particles 32B in a dispersing medium and adding a suitable amount of a material constituting the second protective film 321B, such as lanthanum oxide, to the dispersing medium. Thereafter, the second protective films 321B can be formed by removing the dispersing medium, and performing drying and baking. Note that although lanthanum oxide has been given as an example in the formation method for the second protective films 321B, this formation method may be realized by forming a lanthanum compound on the surfaces of the blue phosphor particles 32B and oxidizing the lanthanum compound thereafter during baking. Also, needless to say, this formation method can be similarly realized even if another metal material is used.

Next, the phosphor layer is formed in the application step by applying the prepared phosphor particle material on an inner side of the glass tube 30 and performing drying. Thereafter, in the metal alkoxide processing step, a metal alkoxide obtained by dissolving yttrium isoproxide in a mixed solvent composed of, for example, butyl acetate and oil of turpentine is applied to the formed phosphor layer and hydrolyzed while performing drying at approximately 100[° C.] for approximately 15 minutes. Moreover, alcohol that is produced as the polymerization reaction of the metal alkoxide progresses is removed by vaporization. Thereafter, in the heat processing step, the phosphor layer 32 is heated in a scintering furnace for an appropriate period of time (at approximately 500[° C.] for approximately 2 minutes), thereby forming the first protective films 320. Note that although it is thought that a few holes will be formed in the first protective films 320 or the second protective films 321B since gas is removed from between the phosphor particles and from the phosphor layer 32 as a result of performing the heat processing step and the like, the phosphor particles are substantially separated from the interior of the glass tube 30 due to the first and second protective films 320 and 321B. Note that although the aforementioned metal alkoxide is used in the present embodiment, a metal carboxylate or the like may be used.

4-4 Experiments for Examination

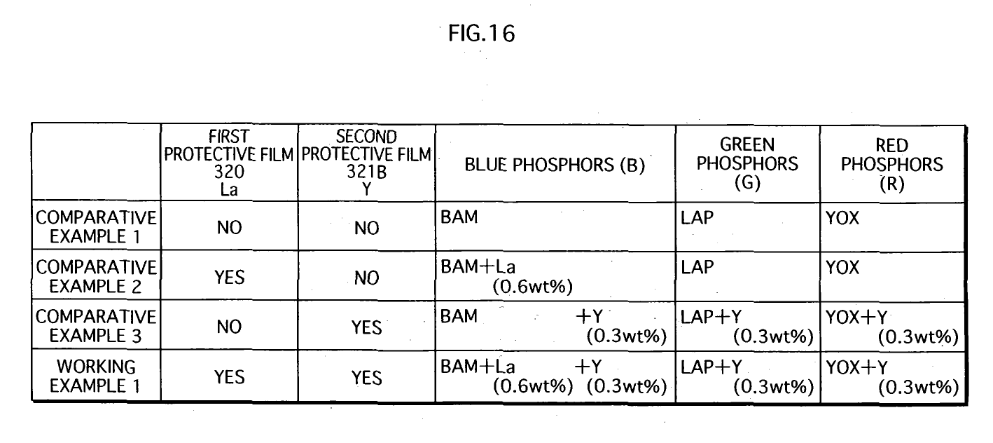

Experiments were performed using the following types of fluorescent lamps in order to examine the luminance and color balance properties of a cold cathode fluorescent lamp 20 including the phosphor layer 32 formed as described above. Comparative examples 1 to 3 and working example 1 differ only with respect to a structure of the phosphor layer, and all other portions are the same (see FIG. 16).

Comparative example 1: a cold cathode fluorescent lamp 201 in which the phosphor layer is not provided with the first or second protective films 320 and 321B

Comparative example 2: a cold cathode fluorescent lamp 202 in which the phosphor layer is not provided with the first protective films 320, and the second protective films 321B are provided on only the blue phosphor particles 32B

Comparative example 3: a cold cathode fluorescent lamp 203 in which the phosphor layer is provided with the first protective films 320, and the second protective films 321B are not provided

Working example 1: the cold cathode fluorescent lamp 20 of the present embodiment in which the first and second protective films 320 and 321B are provided

4.4.1 Examination of Initial Luminance

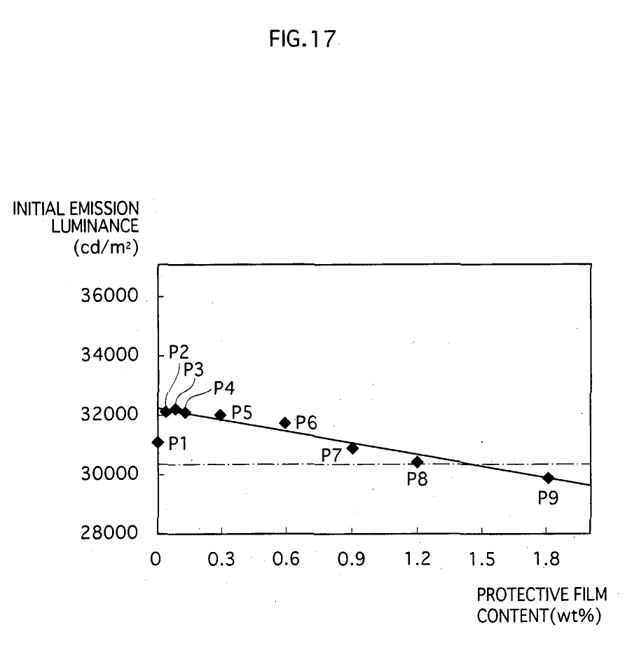

First, in consideration of the effect of the first protective film 320 in suppressing the mercury adsorption, an experiment was performed to examine the amount of the first protective film 320 that needs to be coated in order to ensure a predetermined initial luminance of the phosphor layer 32. In this experiment, a relationship between the coating amount and the initial luminance of the fluorescent lamp was measured. Note that in this experiment, the second protective films 321B were not provided, and only the first protective films 320 were provided as in the comparative example 3. The results of this experiment are shown in FIG. 17. FIG. 17 plots luminance per unit area with respect to protective film content for phosphor particles, and shows a regression line based on the plotted points.

In FIG. 17, points P1 to P9 respectively show, in order, the initial luminance of the fluorescent lamp when the first protective films 320 compose 0 [wt %], 0.05 [wt %], 0.1 [wt %], 0.15 [wt %], 0.3 [wt %], 0.6 [wt %], 0.9 [wt %], 1.2 [wt %], and 1.8 [wt %] of a total weight composition of the phosphor particles. Regarding initial luminance, it has been determined that the same level of emission luminance as the initial luminance can be maintained as long as the deterioration of emission luminance is approximately 3[%], in contrast with the case in which protective films are not provided (point P1) as in the comparative example 1. In general, the variation of emission luminance in the cold cathode fluorescent lamp is said to be a minimum of approximately ±7[%], and moreover, the error percentage of an emission luminance meter used in the measurement is said to be generally 3[%] to 5[%]. In consideration of these points, the emission luminance can be judged to be in the permittable range for practical use if a reduction in the emission luminance is no more than approximately 3[%].

In FIG. 17, cases of the protective film content comprising up to approximately 1.5 [wt %] of the total weight composition of the phosphor particles correspond to a 3[%] reduction in emission luminance, and it can be judged based on the above that the initial luminance has been maintained at the same level. As can be seen in FIG. 17, when the protective film content comprises up to 0.6 [wt %] of the total weight composition of the phosphor particles (point P6), the emission luminance is maintained much more than the point P1 where the first protective film 320 is not provided at all, and it can be said that from the viewpoint of initial emission luminance it is particularly desirable to set the protective films to comprise no more than 0.6 [wt %] of the total weight composition of the phosphor particles.

In accordance with the above, the initial emission luminances in the cases of weight composition percentages such as at points P2 to P6 are higher than at point P1 (comparative example 1), regardless of whether the phosphor layer 32 is covered by the first protective films 320, and this is thought to be due to the fact that in the case of point P1 (comparative example 1), mercury already enclosed in the manufacture of the cold cathode fluorescent lamp 20 has adsorbed to the phosphor particles 32B, 32G, and 32R, and although slight, the phosphor particles 32B, 32G, and 32R do deteriorate. Consequently, it is clear that even a very small amount of the first protective films 320 contributes to an improvement in initial emission luminance, and the inventors of the present invention obtained an initial emission luminance of approximately 32,000 [cd/m²] even when the protective films composed 0.01 [wt %] of the total weight composition of the phosphor particles, which is thought to be the same effect.

It is therefore desirable for the first protective films 320 to compose 0.01 [wt %] to 1.5 [wt %] inclusive, or in particular, 0.05 [wt %] to 0.6 [wt %] inclusive of the total weight composition of the phosphor particles 32B, 32G, and 32R.

4.4.2 Examination of Color Balance

However, in order to maintain color balance, which is a requirement for realizing a lengthening of the life of the cold cathode fluorescent lamp 20, it is necessary to not only control deterioration of the phosphor layer 32, but also reduce disparities between the adsorption of mercury to the phosphor particles 32B, 32G, and 32R. In particular, in the case of using the materials pertaining to the present embodiment, mercury is considered to more readily adsorb to the blue phosphor particles 32B than the green and red phosphor particles 32G and 32R, whereby the blue phosphor particles more readily deteriorate.

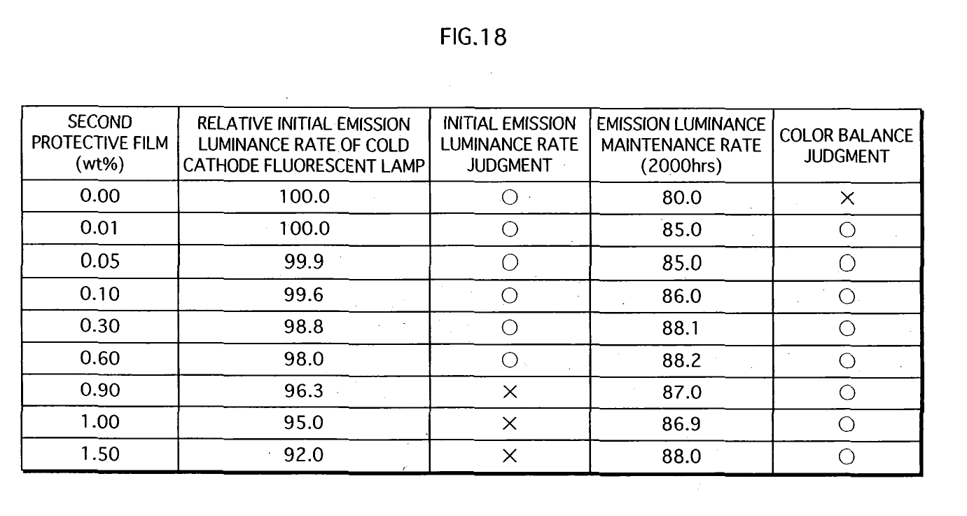

Based on results obtained from the aforementioned experiment (examination of initial emission luminance), the first protective films 320 were provided, and the blue phosphor particles 32B were coated with the second protective films 321B as in the aforementioned working example 1, and an experiment was performed in which the weight percentage of the second protective films 321B with respect to the total weight composition of the blue phosphor particles 32B was varied, and variations in the initial emission luminance and color balance were examined. Results of this experiment are shown in FIG. 18.

In FIG. 18, the initial emission luminance when the blue phosphor particles 32B are not coated at all by the second protective films 321B (0[%]) is set as a reference value, and relative initial emission luminance rates in cases of respective weight composition percentages of the second protective films 321B are shown in order. In FIG. 18, “◯” indicates when a reduction in emission luminance is less than 3[%] and it is judged that the emission luminance has been maintained at the same level as the initial emission luminance, and “X” indicates when a reduction in emission luminance is 3[%] or more and it is judged that there has been a degredation of the initial emission luminance. FIG. 18 also shows emission luminance maintenance rates after 2,000 hours of operation, and “X” indicates when there has been a large shift in the color balance and there is the possibility of color shift, and “◯” indicates when there has not been a degredation in color balance and the occurrence of color shift has been greatly suppressed. Note that color shift values were used as indicators of a reduction in color balance in the above judgment, and given that the color shift value when the first and second protective films 320 and 321B are not provided on the phosphor particles 32B, 32G, and 32R as in comparative example 1 is approximately 0.02 after 2,000 hours of operation, “X” indicates when the color shift value of the second protective films 321B after 2,000 hours of operation are greater than 0.02, and “◯” indicates when the color shift value is 0.02 or less.

As is clear in FIG. 18, coating specifically the blue phosphor particles 32B with a rare earth oxide, such as a coating of the second protective films 321B, is effective in maintaining color balance and emission luminance. Also, from the viewpoint of the initial emission luminance rate, it is preferable for the second protective films 321B to compose 0.6 [wt %] or less of the total weight composition of the blue phosphor particles 32B.

The results of these examinations, in addition to the result of the examinations of 4.4.1, lead to the following content.

First, from the viewpoint of initial emission luminance, the first and second protective films 320 and 321B are set to compose no more than 1.5 [wt %] of the total weight composition of the phosphors 32B, 32G, and 32R.

Second, from the viewpoint of color balance, the second protective films 321B are formed so as to compose approximately 0.01 [wt %] to 0.60 [wt %] inclusive of a total weight composition of the blue phosphor particles 32B, in order to specifically suppress mercury adsorption to the blue phosphor particles 32B more than to the green and red phosphor particles 32G and 32R.

In order to satisfy both of the above, and in consideration of keeping the weight composition percentage of the second protective films 321B in the aforementioned range with respect to the total weight composition of the blue phosphor particles 32B, it is preferable for the first protective films 320 to compose 0.01 [wt %] to 0.90 [wt %] inclusive of the total weight composition of the phosphor particles 32B, 32G, and 32R, and furthermore for the second protective films 321b to be formed so as to compose approximately 0.01 [wt %] to 0.60 [wt %] inclusive of the total weight composition of only the blue phosphor particles 32B.

Providing the phosphor layer with the first and second protective layers 320 and 321B as mentioned above enables the effect of suppressing mercury adsorption to the phosphor particles 32B, 32G, and 32R, and simultaneously enables the suppression of a reduction in the color balance. In particular, limiting the first protective films 320 to compose 0.05 [wt %] to 0.06 [wt %] of the total weight composition of the phosphor particles 32B, 32G, and 32R achieves the effect of raising the initial emission luminance as mentioned in 4.4.1, which is preferable.

4.4.3 Examination of Luminance Factor Variations

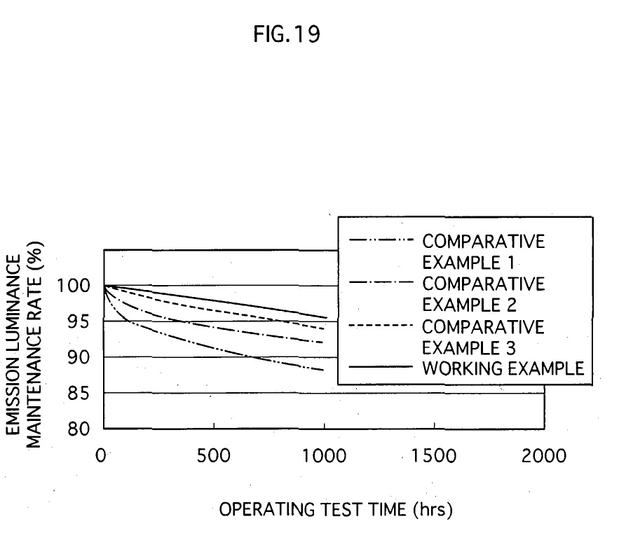

Based on the aforementioned 4.4.1 and 4.4.2, an experiment was performed to compare the cold cathode fluorescent lamp 20 (working example 1) in which the phosphor layer 32 is provided with the first and second protective films 320 and 321B within the above-mentioned weight composition percentage ranges, and the other cold cathode fluorescent lamps 201, 202, and 203 (comparative examples 1 to 3), and to examine rates of emission luminance maintenance. FIG. 19 shows results of this experiment.

FIG. 19 is a graph showing emission luminance maintenance rates, and was created based on emission luminances after 500 hours and 1,000 hours of operation, where the respective initial emission luminances of the working example 1 and the comparative examples 1 to 3 are set as 100. As is clear from FIG. 19, only working example 1 has maintained an emission luminance maintenance rate of 95[%] or more even after 1,000 hours of operation. Cold cathode fluorescent lamps are generally said to have a life of 50,000 to 60,000 hours, and it is previously known that emission luminance maintenance rates drop drastically as the time of operation elapses. In other words, it can be easily judged that the differences in variations between emission luminance maintenance rates in FIG. 19 after 1,000 hours of operation would be dramatically larger after 50,000 to 60,000 hours of operation. Consequently, there are large differences in the lives of the cold cathode fluorescent lamps of working example 1 and comparative examples 1 to 3. As a result, providing the first and second protective films 320 and 321B in the aforementioned ranges of weight composition percentages as in working example 1 makes it possible to realize a lengthening of the life of the cold cathode fluorescent lamp 20.

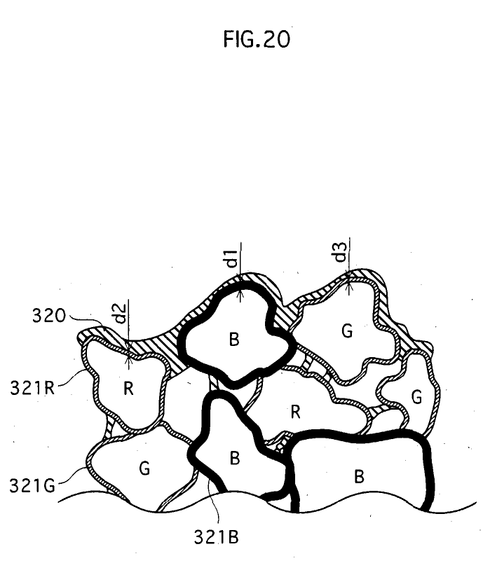

Note that although the second protective films 321B coat only the blue phosphor particles 32B in the present embodiment, the green and red phosphor particles 32G and 32R may be coated with second protective films 321G and 321R respectively, as shown in FIG. 20. However, it is necessary to, for example, make a film thickness d1 of the second protective films 321B of the blue phosphor particles 32B larger than film thicknesses d2 and d3 of the second protective films 321G and 321R, and to make the second protective films 321B compose a relatively large percentage of the total weight composition of the blue phosphor particles 32B. In other words, it is preferable for the weight composition percentage of the second protective films 321B with respect to the blue phosphor particles 32B to be 0.01 [wt %] to 0.6 [wt %] greater than the weight composition percentage of the second protective films 321G and 321R with respect to the green and red phosphor particles 32G and 32R.

Also, when the phosphor layer 32 is constituted from piled phosphors 32B, 32G, and 32R as in FIG. 15 and FIG. 20, it is preferable from the viewpoint of suppressing mercury adsorption to reliably form the first protective films 320 so as to reliably separate the top layer of the phosphor layer 320 and spaces between the phosphor particles 32B, 32G, and 32R. However, the first protective films 320 is applicable even if formed in the spaces with holes therein, since similar effects can be obtained as long as the first protective film 320 with the effect of suppressing mercury adsorption is formed so as to encompass portions of the phosphor particles 32B, 32G, and 32R. In particular, based on the viewpoint of suppressing the effect of mercury adsorption and the reduction in emission luminance, holes portions are thought to additionally be very effective with respect to suppressing the reduction in emission luminance.

Also, if all of the phosphor particles 32B, 32G, and 32R are coated with the second protective films 321B, 321G, and 321R respectively, and furthermore a coating film (the second protective film 321B) is specifically formed on the blue phosphor particles 32B, similar effects may be obtained and it is not necessary to form the first protective films 320.

### Embodiment 5

Next is a description of a cold cathode fluorescent lamp pertaining to embodiment 5. However, embodiment 5 differs from the aforementioned embodiment 4 only with respect to a structure of a phosphor layer 42, and descriptions of other portions have been omitted.

5.1 Structure of the Phosphor Layer 42

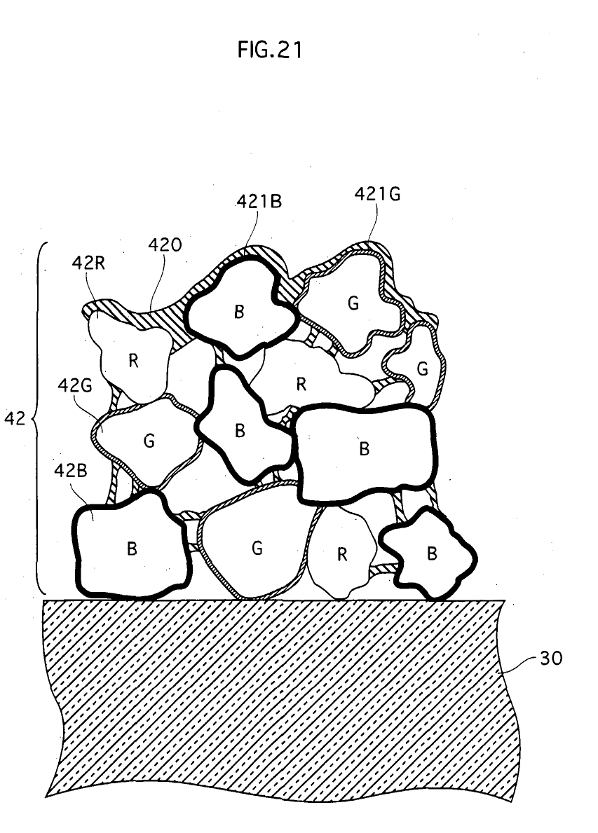

As shown in the schematic view of FIG. 21, the phosphor layer 42 pertaining to the present embodiment is provided with first protective films 420, and second protective films 421B and 421G that coat blue phosphor particles 42B and green phosphor particles 42G.

The first protective films 420 are composed of yttrium oxide, and the second protective films 421B and 421G are composed of yttrium oxide.

The blue phosphor particles 42B are composed of SR₅(PO₄)₃Cl:Eu²⁺ (SCA), the green phosphor particles 42G are composed of BaMg₂Al₁₆O₂₇:Eu²⁺, Mn²⁺ (BAMMn), and the red phosphor particles 42R are composed of YVO₄:Eu³⁺ (YVO).

From among the aforementioned materials composing the phosphor particles 32B, 32G, and 32R, mercury more readily adsorbs to the blue and green phosphor particles 42B and 42G than the red phosphor particles 42R. Time degredation due to mercury adsorption is suppressed by forming the second protective films 421B and 421G as shown in FIG. 21, and there is not a large difference in the rate of degradation of the blue and green phosphor particles 42B and 42G when compared with the red phosphor particles 42R. In the present embodiment as well, it is therefore possible to not only suppress deterioration of the initial emission luminance rate and the emission luminance maintenance rate, but also suppress a reduction in color balance over time.

Note that using the phosphor particle materials of the present embodiment has the effect of improving color reproducibility over embodiment 4. Note that the materials composing the phosphor particles 42B, 42G, and 42R are not limited to the aforementioned materials. Other materials can be applied. For example, the blue phosphor particles 42B may be composed of BAM or the like, the green phosphor particles 42G may be composed of Ce(Mg,Zn)Al₁₁O₁₉:Mn²⁺ (CMZ), CeMgAl₁₁O₁₉:Tb³⁺ (CAT), CeMgAl₁₁O₁₉:Tb³⁺, Mn²⁺ (CAM), Zn₂SiO₄:Mn²⁺ (ZSM), or the like, and the red phosphor particles may be composed of Y₂O₂S:Eu³⁺ (YOS), Y(P,V)O₄:Eu³⁺ (YPV), 3.5 MgO.0.5 MgF₂.GeO₂:Mn⁴⁺ (MFG), or the like.

Also, it is preferable for the weight composition percentages of the first protective films 420 and the second protective films 421B and 421G with respect to the phosphor particles to be in the aforementioned ranges. The red phosphor particles 42R may also be coated with the second protective films in the present embodiment as long as within the aforementioned ranges. Furthermore, the first protective films 420 need not be formed as long as the second protective films are formed on the all of the phosphor particles 42B, 42G, and 42R, and the blue and green phosphor particles 42B and 42G are specifically formed so as to, for example, satisfy the prescribed weight composition percentages.

Other Remarks

Although the first and second protective films are composed of the different materials in embodiment 4 and the same materials in embodiment 5, the present invention is not limited to this. The first and second protective films may be composed of the same material in embodiment 4, and different materials in embodiment 5.

Also, although the glass tube is composed of lead-free glass, soda-lime glass which has a lower melting point than borosilicate glass and is easily moldable can be applied. In this case, it is preferable to provide, for example, a suppression film between the phosphor layer and the glass tube to suppress the generation of sodium oxide or sodium from the glass tube to the interior of the phosphor layer since sodium and the like is generated during manufacture and use of the fluorescent lamp and is a cause for luminance reduction.

Although the manufacturing method involves applying the metal compound after forming the phosphor layer, the present invention is not limited to this. For example, the metal compound and the phosphor particle materials may be mixed in advance and formed on the inner side of the glass tube. In this case, however, the metal alkoxide processing step and the heat processing step in the aforementioned manufacturing method are unnecessary, and it is necessary to modify the drying time and temperature settings in the phosphor particle material preparation step.

### Embodiment 6

There are cold cathode fluorescent lamps in which a phosphor layer is formed on an inner side of a tube-shaped glass container, and being provided with cold cathodes at both ends as inner electrodes. Such cold cathode fluorescent lamps are suited for having a small diameter. For this reason, these cold cathode fluorescent lamps are favorably used as a light source in thin (small) backlight units.

Also, it is demanded that the light source of a backlight unit have, in particular, a long life, i.e., to have a superior luminance maintenance rate. The deterioration of phosphors and the consumption of mercury are given as causes of a reduction in luminance that occurs over time. The deterioration of phosphors and the consumption of mercury are thought to occur in the following way.

Conventionally, a phosphor layer is constituted from a countless number of phosphor particles and connecting bodies that connect the phosphor particles and are composed of, for example, exclusively CBB (alkaline earth metal borate). The CBB is composed of particles that are smaller than the phosphor particles, and connects the phosphor particles by adhering to contact points therebetween. For this reason, a large portion of a surface of the phosphor particles is thought to be exposed.

The phosphor layer is exposed to bombardment of mercury ions generated during operation of the cold cathode fluorescent lamp. In the case of the aforementioned conventional phosphor layer, exposed portion of the phosphor particles are bombarded with mercury ions, and a crystal structure of the bombarded portions changes to a non-light-emitting crystal structure. Also, some of the mercury ions that struck the phosphor particles and the CBB remain in the phosphor particles and the CBB. This results in the gradual consumption of mercury that acts to emit ultraviolet radiation.

Domestic Republication of PCT International Application WO 2002/047112 discloses a fluorescent lamp in which the phosphor layer is formed using a metal oxide in instead of the aforementioned CBB. This is because metal oxides generally have the property of preventing mercury ions from penetrating into the phosphor layer. The aforementioned domestic republication discloses that “The phosphor layer includes a plurality of phosphor particles and a metal oxide that adheres to contact portions (connecting portions) of the phosphor particles and is disposed such that surfaces of the phosphor particles are partially exposed” (the content within the parentheses has been added by the applicant of the present application). In other words, the metal oxide covers a surface of the connecting portions and at least a portion of non-connecting portion surfaces of the phosphor particles in the phosphor layer of the aforementioned domestic republication.

The non-connecting portions of surfaces of the phosphor particles of the aforementioned domestic republication are covered by the metal oxide that prevents mercury ion penetration, and there are fewer exposed portions than in the case of conventional phosphor particles. This eliminates degredation of the phosphor particles due to bombardment from mercury ions and the consumption of mercury due to the mercury remaining in the phosphor particles. Also, forming the connecting bodies from the metal oxide eliminates the consumption of mercury in the connecting portions. This results in a fluorescent lamp with a luminance maintenance ratio that is superior to that of conventional fluorescent lamps.

However, although slight, the metal oxide does have the characteristic of absorbing visible light, whereby the initial luminance of the fluorescent lamp in the aforementioned domestic republication is reduced.

Note that the same issue arises not only with internal electrodes, but also when using an external electrode fluorescent lamp (EEFL) in which external electrodes are provided on an outer circumference of the glass container.

The present invention pertaining to embodiment 6 and the later-mentioned embodiment 7 aim to provide a fluorescent lamp capable of having a high luminance maintenance ratio while improving the initial luminance over that of conventional fluorescent lamps.

First, the following describes a cold cathode fluorescent lamp 510 pertaining to the present embodiment.

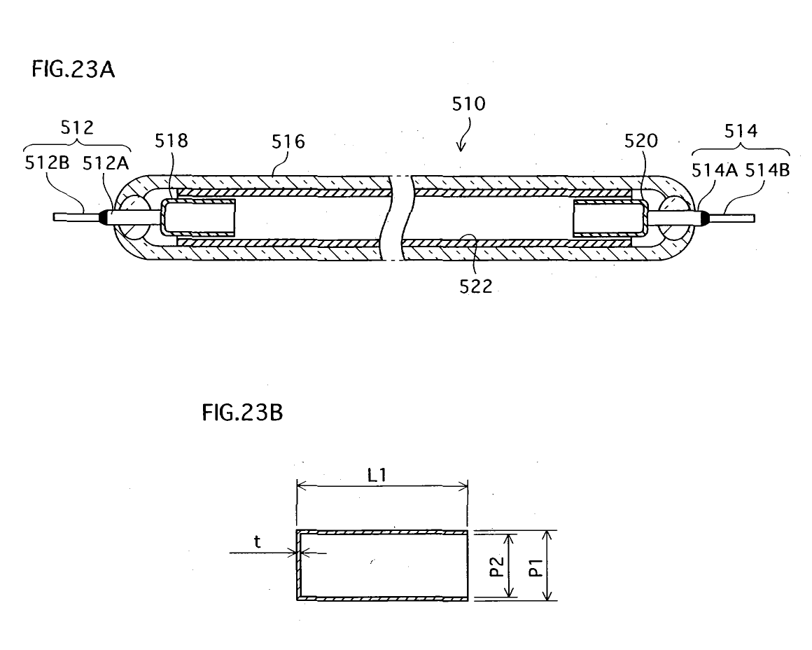

FIG. 23A is a cross-sectional view showing a schematic structure of the cold cathode fluorescent lamp 510, including a tube axis thereof, pertaining to embodiment 6. FIG. 23B is a magnified view of electrode 518 in FIG. 23A.

The cold cathode fluorescent lamp 510 is constituted from a glass container 516 composed of a glass tube that has a circular cross section and whose ends are hermitically sealed by lead wires 512 and 514. The glass container 516 is composed of hard borosilicate glass, and has a length of 720 [mm], an outer diameter of 3 [mm], and an inner diameter of 2 [mm].

Also, approximately 2 [mg] of mercury (not depicted) and a mixed gas (not depicted) composed of rare gases such as argon (Ar) and neon (Ne) are enclosed in the glass container 516.

The lead wires 512 and 514 are each continuous wires composed of inner lead wires 512A and 514A formed from tungsten and outer lead wires 512B and 514B formed from nickel. Both ends of the glass tube are hermitically sealed at inner lead wire 512A and 514A portions. The inner lead wires 512A and 514a and the outer lead wires 512B and 514B have circular cross sections cut vertically with respect to the tube axis. The inner lead wires 512A and 514A have a diameter of 1 [mm] and a length of 3 [mm], and the outer wires 512B and 514b have a diameter of 0.8 [mm] and a length of 10 [mm].

Electrodes 518 and 520 are affixed to inner ends of the glass container 516 where the inner lead wires 512A and 514a are supported by the glass container 516. The electrodes 518 and 520 are so-called hollow electrodes which are cylindrical and have a bottom, and are constituted from a processed niobium rod. Using hollow electrodes as the electrodes 518 and 520 is effective in suppressing sputtering at the electrode that occurs due to discharges during operation (for specifics, see Japanese Patent Application Publication No. 2002-289138).

The electrodes 518 and 520 have the same shape, and have the following measurements shown in FIG. 23B: electrode length L1=5 [mm], outer diameter p1=1.70 [mm], thickness t=0.10 [mm], (and inner diameter p2=1.50 [mm]).

Also, a phosphor layer 522 with a thickness of approximately 16 [μm] has been formed on an inner side of the glass container 516.

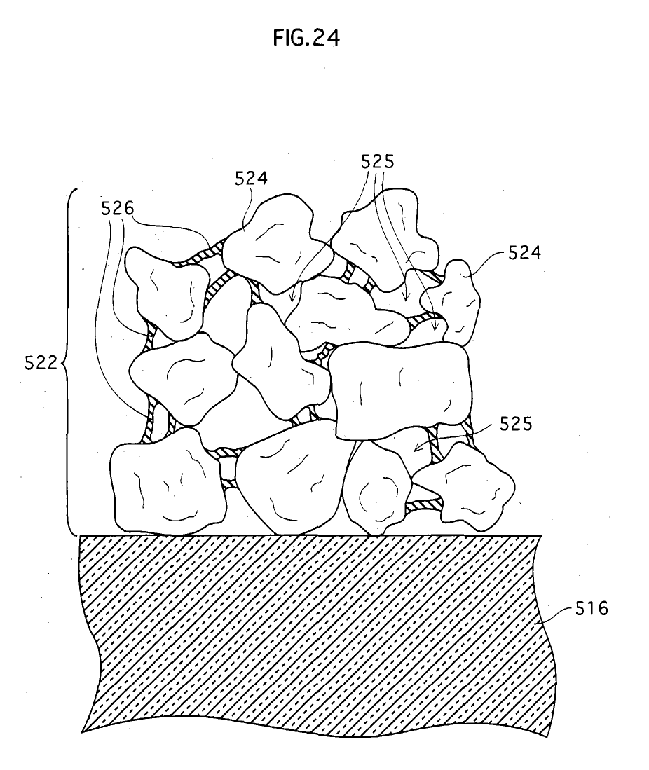

FIG. 24 is an enlarged view of the phosphor layer 522.

The phosphor layer 522 includes phosphor particles 524 and rod-shaped bodies 526 that cover the phosphor particles 524 as well as join the phosphor particles 524 by spanning therebetween.

Each of the phosphor particles 524 is any of three types of rare earth phosphors such as a red phosphor composed of Eu-activated yttrium oxide (Y₂O₃:Eu³⁺), a green phosphor composed of Ce/Tb-activated lanthanum phosphate (LaPO₄:Ce³⁺, Tb³⁺), and a blue phosphor composed of Eu-activated barium magnesium aluminate (BaMg₂Al₁₆O₂₇:Eu²⁺). The phosphor particles are mixed in a predetermined ratio.

Components of the rod-shaped bodies 526 include an alkaline earth metal borate (hereinafter, called “CBB”) as well as yttrium oxide (Y₂O₃) that has been doped with trivalent europium ions (Eu³⁺) (hereinafter, called an Eu-activated yttrium oxide connecting agent). Both of the components constituting the rod-shaped bodies 526 interconnect the phosphor particles 524 as well as affix the phosphor particles 524 to the inner wall of the glass container 516.

Additionally, the Eu-activated yttrium oxide connecting agent prevents ionized mercury (mercury ions) generated during operation of the lamp from penetrating into the phosphor layer. This protects the phosphor particles from being bombarded by the mercury ions. Also, the mercury emits 185 [nm] and 254 [nm] ultraviolet radiation, and the Eu-activated yttrium oxide connecting agent blocks 185 [nm] ultraviolet radiation (blocks at least 70[%]) and transmits 254 [nm] ultraviolet radiation (transmissivity is approximately 85[%]). 185 [nm] ultraviolet radiation deteriorates phosphors. 254 [nm] ultraviolet radiation exclusively excites the phosphors and is converted into visible light.

Conventionally, solely yttrium oxide is used as the metal oxide in the connecting agent, as mentioned above. In the present embodiment, the addition (doping) of trivalent europium as an activator causes the rod-shaped bodies to emit red light. Consequently, the present embodiment improves luminance (initial luminance) over conventional fluorescent lamps since the connecting bodies which conventionally absorb visible light (though slightly) emit light in the present embodiment. Also, a surface layer of the rod-shaped bodies 526 receives a large amount of ultraviolet radiation due to directly facing the discharge space, and therefore emits light at a high luminance.

Also, in the present embodiment, the amount of red phosphor particles can be reduced since the rod-shaped bodies emit red light, thereby making it possible to commensurately increase the amount of the green and/or blue phosphor particles. In particular, increasing the amount of the green phosphor particles improves the emission efficiency (luminous efficiency of radiation) due to increasing the emitting color component whose wavelength range has a high relative luminance.

In addition to the Eu-activated yttrium oxide connecting agent, CBB which is the other constituent element of the rod-shaped bodies 526 is added mainly to increase the connecting ability of the rode-like bodies 526. Note that CBB also transmits 254 [nm] ultraviolet radiation.

The phosphor layer 522 includes gaps 525 since the rod-shaped bodies 526 connect the phosphor particles 524 by spanning therebetween. Given that the ultraviolet radiation generated by discharges can reach to roughly an entire depth of the phosphor layer 522 in the thickness direction due to the presence of these gaps 525, the phosphor layer 522 overall efficiently emits light.

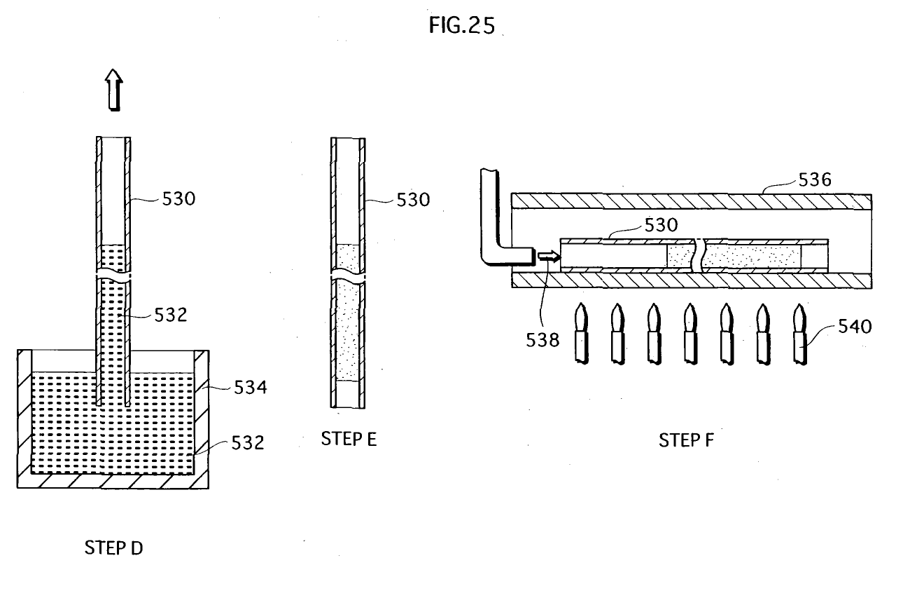

Next is a description of steps related to the formation of the phosphor layer 522 in the manufacturing process for the cold cathode fluorescent lamp 510 having the aforementioned structure, with reference to FIG. 25.

First, in a step D in FIG. 25, a suspension including phosphor particles is applied to an inner side of a glass tube 530 that constitutes the glass container 516.

Specifically, there is provided a tank 534 filled with a suspension 532. The suspension 532 includes a mixed solvent composed of butyl acetate and oil of turpentine to which a predetermined amount of phosphor particles, yttrium carbonate [Y (CₙH₂ₙ₊₁COO)₃], europium carbonate [Eu³⁺ (CₙH₂ₙ₊₁COO)₃], CBB particles, and a nitrocellulose (NC) thickening agent have been added.

The glass tube 530 is stood vertically, and a bottom end thereof is immersed and held in the suspension 532. Suction from a vacuum pump not depicted is used to evacuate the interior of the glass 530 from the top end, thereby creating negative pressure and sucking the suspension 532 up into the glass tube 530. A surface of the suspension is sucked up into the glass tube 530 and stopped (at a predetermined height) before reaching the top end, and the glass tube 530 is lifted out of the suspension liquid 532.

This applies the suspension 532 in the form a film to a predetermined area of an inner circumference of the glass tube 530.

Warm dry air (25[° C.] to 30[° C.]) is blown into the glass tube 530 to dry the suspension 532 applied in the form of a layer (this step is not shown), and thereafter, a portion of the dried film in a vicinity of the end through which the suspension 532 was sucked in step D is removed (step E).

Next, as shown in step F, the glass tube 530 is inserted into and laid down in a quartz tube 536, and baking (scintering) is performed for approximately 5 minutes by using burners 540 to externally apply heat to the quartz tube 536 while supplying air 538. A temperature of the heat applied by the burners 540 is set such that the inner circumferential surface of the glass tube 530 becomes 650[° C.] to 750 [° C.].

Vitrified Eu-activated yttrium oxide (Y₂O₃:Eu³⁺), which is to be the connecting agent, is formed from the yttrium carbonate and the europium carbonate due to thermal decomposition during baking. Note that beside yttrium oxide and europium, a hydrocarbon represented by the general formula CₙH₂ₙ₊₂ is produced at this time.

Also, the CBB particles fuse to form a vitrified film in the aforementioned baking step.

This completes the description of the formation of the phosphor layer 522 (FIGS. 23A and 23B, and FIG. 25).

### Embodiment 7

The following is a description of a fluorescent lamp 550 pertaining to embodiment 7.

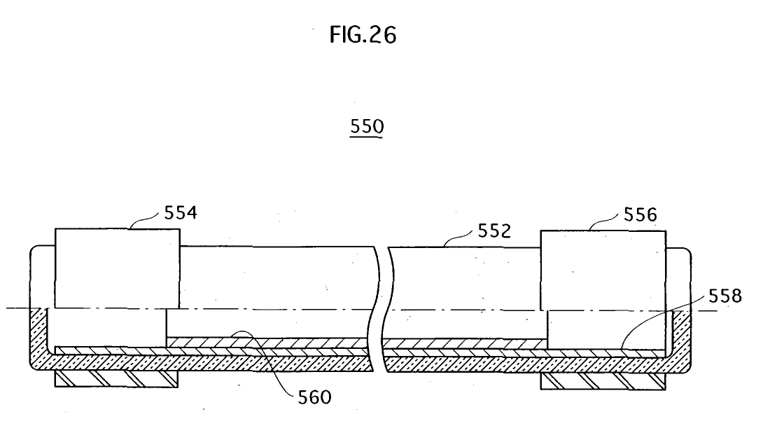

FIG. 26 is a half cross-sectional view showing a schematic structure of the fluorescent lamp 550 pertaining to embodiment 7.

The fluorescent lamp 550 is an external electrode fluorescent lamp, and includes a glass container 552 constituted from a glass tube that is composed of soda glass and whose ends have been hermitically sealed. The glass container 552 has a total length of 740 [mm], an outer diameter of 4.0 [mm], and an inner diameter of 3.0 [mm].

A first external electrode 554 and a second external electrode 556 are formed on an outer circumference of the ends of the glass container 552. The first and second external electrodes 554 and 556 have a width (a length in the tube axis direction of the glass container) of 20 [mm], and are formed around an entire circumference of the glass container 552. Note that although not depicted, the first and second external electrodes 554 and 556 have a 2-layered structure. The layer that is closer to the glass container 552 is formed from a silver (Ag) paste film, and the layer further away from the glass container 552 is formed from a lead (Pb) free solder film. Note that the first and second external electrodes 554 and 556 are not limited to having a 2-layered structure. Either may have a single-layer structure. Also, the first and second external electrodes 554 and 556 are not limited to the aforementioned materials. The first and second external electrodes 554 and 556 may be formed by, for example, winding a metallic tape composed of copper, aluminum, etc. around an external circumference of the glass container 552.

Also, a predetermined amount of mercury and a mixture of rare gases are enclosed in the glass container 552 at a predetermined pressure. In the present embodiment, approximately 2,000 [μg] of mercury is enclosed in the glass container 552, and the mixture of rare gases is a 20° C. neon-argon mixed gas (90[%] Ne+10[%] Ar) at approximately 7 [kpa].

A protective layer 558 with a thickness of 10 [μm] is formed on substantially an entire surface of the inner circumferential surface of the glass container 552, including portions thereof that oppose the first and second external electrodes 554 and 556.

A phosphor layer 560 with a thickness of 18 [μm] is formed on an inner side of the protective layer 558 by lamination. The phosphor layer 560 is formed between the first and second external electrodes 554 and 556 in a tube axis direction of the glass container 552. Note that portions of the phosphor layer 560 may overlap an inner circumferential surface portion of the glass container 552 that opposes the first and second external electrodes 554 and 556.

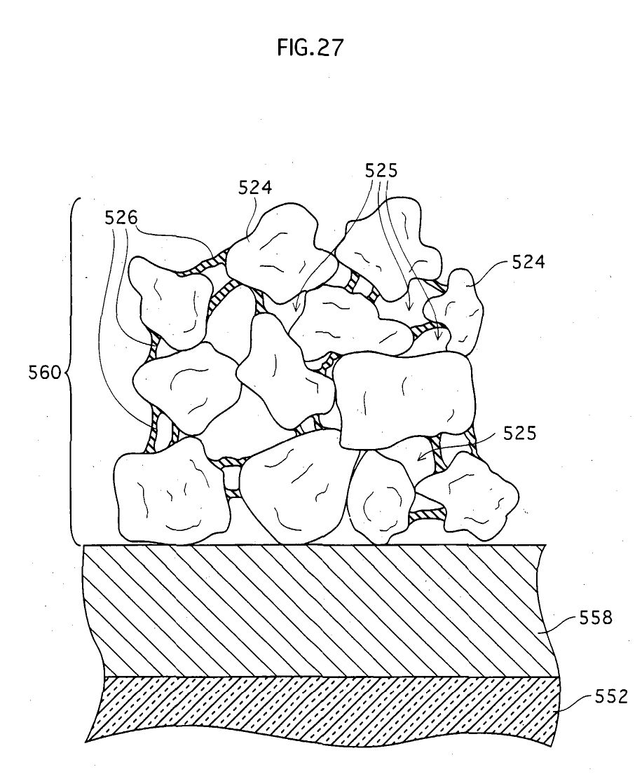

FIG. 27 is an enlarged view of the protective layer 558 and the phosphor layer 560.

The phosphor layer 560 has basically the same structure as the phosphor layer 522 (shown in FIG. 24) of embodiment 7. In other words, the phosphor layer 560 includes phosphor particles 524 and rod-shaped bodies 526 that cover the phosphor particles 524 as well as span therebetween. The rod-shaped bodies 526 also connect the phosphor particles 524 by spanning therebetween so as to form gaps 524. Note that the phosphor particles 524 are also composed of the same phosphor materials as in embodiment 6, and the rod-shaped bodies 526 include the same components as in embodiment 6.

Components of the protective layer 558 include an yttrium oxide (Y₂O₃) that has been doped with trivalent europium ions (Eu³⁺) (hereinafter, called an Eu-activated yttrium oxide connecting agent). The protective layer 558 is formed with the aim of preventing the sodium component that elutes from the glass container 552 composed of soda glass from deteriorating the phosphor particles 524, and preventing the mercury from reacting (combining) with the sodium component and being consumed.

The formation of the protective layer 558 on the inner side of the glass container 552 can be realized by using a method basically the same as was used to form the phosphor layer 522 in embodiment 6, except for a structure of the suspension. The suspension used to form the protective layer 558 is the same as the suspension of embodiment 6 except for the removal of the phosphor particles and the CBB. In other words, the suspension used to form the protective layer 558 is composed of an organic solvent composed of butyl acetate to which yttrium carbonate [Y (CₙH₂ₙ₊₁COO)₃], europium carbonate [Eu³⁺ (CₙH₂ₙ₊₁COO)₃], and a nitrocellulose (NC) thickening agent have been added. Also, similarly to the case in embodiment 6, the suspension is applied to the inner side of the glass tube, baking (scintering) is performed thereafter, thereby producing the protective layer 558. As shown in FIG. 27, the protective layer 558 covers the inner side of the glass container 522 substantially without gaps.

In the fluorescent lamp 550 having the aforementioned structure, upon using an inverter to apply a high frequency voltage to the first and second external electrodes 554 and 556, a discharge phenomenon occurs in the hermitically sealed space (discharge space) in the glass container 552, producing ultraviolet radiation. This ultraviolet radiation is converted into visible light by the phosphor particles 524, and the visible light is emitted out of the glass container 552. Also, given that the rod-shaped bodies 526 emit red light in the present embodiment, similarly to embodiment 6, the same effects as described in embodiment 6 are achieved. Moreover, the protective layer 558 also emits a slight amount of red light in the fluorescent lamp 550 of the present embodiment, thereby improving luminance to a commensurate degree.

The inverter can have, for example, a maximum applied voltage of 2.5 [kV], and an operating frequency of 60 [kHz]. The aforementioned discharge is a dielectric barrier discharge. In other words, upon applying a high frequency/high voltage alternating current to the first and second external electrodes 554 and 556, dielectric polarization occurs at portions of the glass container 552, which is a dielectric, directly below the first and second external electrodes, and the inner wall of the glass container 552 at such portions acts as an electrode. As a result, a high voltage is induced in the glass container 552, and a dielectric barrier discharge occurs therein. In this way, the dielectric barrier discharge is a discharge in which the discharge space is surrounded by a dielectric (the glass container 552), and plasma does not contact the electrodes.

Although the electrodes (external electrodes) and the plasma do not contact, mainly inner circumferential portions of the glass container 552 corresponding to disposition areas of the external electrodes are bombarded by mercury ions, neon ions, and argon ions. The protective layer 558 protects the glass container 552 from the bombardment of such ions.

(1) Although described using examples of applying the present invention to a cold cathode fluorescent lamp and an external electrode fluorescent lamp in embodiments 6 and 7, the present invention is not limited to this. For example, the present invention may be applied to a hot cathode fluorescent lamp. Essentially, the present invention can be applied as long as the fluorescent lamp has a phosphor layer (composed of phosphor particles and rod-shaped bodies) that is excited by ultraviolet radiation to emit light.

(2) Although yttrium oxide (Y₂O₃) is used as an example of the metal oxide constituting the rod-shaped bodies and the protective layers in embodiment 6 and 7, the present invention is not limited to this. Lanthanum oxide (La₂O₃) may be used instead.

(3) Also, the activator added to the metal oxide is not limited to europium. For example, the activator may be selected from among cerium, terbium, gadolinium, titanium, zirconium, vanadium, niobium, tantalum, molybdenum, tungsten, lanthanum, praseodymium, neodymium, samarium, dysprosium, holmium, erbium, thulium, ytterbium, and lutetium. Note that, among these, the use of europium (Eu), cerium (Ce), or terbium (Tb) is favorable. This is because these three elements have a higher luminous efficiency than the other activators listed above. Also, addition of the activator is not limited to one type. More than one type of activator may be used.

(4) As previously mentioned, the amount of red phosphor particles in embodiments 6 and 7 can be reduced since the rod-shaped bodies and the protective layer emit red light, thereby making it possible to increase of the amount of the green and blue phosphor particles. However, the emitted color of light may be something other than red, depending on the combination of the metal compound and the activator. In this case, the ratio of the three types of phosphor particles need only be modified in accordance with the increased color of light.

(5) Materials from which the protective layer is formed are not limited to the material shown in embodiments 6 and 7. For example, alumina (Al₂O₃), silica (SiO₂), ytteria (Y₂O₃), titanium oxide (TiO₂), or the like may be used.

(6) Although the rod-shaped bodies are present in substantially an entire depth of the phosphor layer in the thickness direction thereof in embodiments 6 and 7, the present invention is not limited to this. For example, the structure of the phosphor layer may be as indicated below.

Specifically, a layer composed of solely phosphor particles (hereinafter, called a “phosphor particle layer”) is formed continuously on an inner side of the glass container (or on the protective layer). A layer composed of the rod-shaped bodies is formed to cover the phosphor particle layer such that a portion of the layer penetrates between the top phosphor particles. In this case as well, at least the top phosphor particles of the phosphor particle layer are covered by the rod-shaped bodies, and are furthermore connected by the spanning rod-shaped bodies with gaps formed therebetween.

### Embodiment 8

An external electrode fluorescent lamp has a structure in which external electrodes are disposed on an outer circumference of ends of a glass container composed of a glass tube whose ends have been sealed. Mercury and a mixed gas composed of more than one type of rare gas, for example, are enclosed in the hermitically sealed glass container at a pressure lower than atmospheric pressure.

An external electrode fluorescent lamp having such a structure is manufactured by, for example, the following steps (Japanese Patent Application Publication No. 2004-253360).

There is provided a glass tube whose ends have not been sealed, and a first end is sealed at atmospheric pressure by using a burner, etc. to heat and melt the first end to cause closure of the first end (first seal).

Bead glass is inserted into the glass tube from a second end, and fixed at a predetermined position in the tube axis direction. Here, the interior of the glass tube from the bead glass to the first end in the tube axis direction becomes the discharge space of the completed lamp.

After inserting a mercury pellet into the glass tube through the second end, the glass tube is evacuated, the rare gases are filled into the glass tube, and the second end is sealed by heating the second end to causing melting and closure thereof (tentative seal). At this time, the evacuation of the glass tube and the filling of the rare gases are performed via a hollow portion in the bead glass if a bead glass having a hollow portion is used, and via a gap between the bead glass and the glass tube inner circumferential surface if the bead glass has a solid core. Here, the interior of the glass tube is at a negative pressure.

Second sealing is performed after expelling mercury from the mercury pellet into the discharge space.

The second seal is performed by using a burner, etc. to heat and melt an outer circumferential portion of the glass tube in the vicinity of the bead glass portion, but more toward the second end (tentatively sealed part) than the bead glass. The tentatively sealed part is separated, whereby the hermitically sealed glass container is complete.

The external electrode fluorescent lamp is completed by disposing external electrodes on ends of the hermitically sealed glass container. The external electrodes are formed by winding a metallic tape around an external circumference of the glass tube, by screen-printing a metallic paste on an outer circumference of the glass container, etc.

However, leaving aside the first seal, unnecessary portions of the glass tube are shrunk when the second seal is performed in the aforementioned manufacturing method. As mentioned above, the second seal is performed using a burner to heat and melt the glass tube in the vicinity of the bead glass portion, and given that there is a negative pressure in the glass tube, the melted or softened glass tube portion is pulled inward in the diameter direction, and the outer diameter is reduced. At this time, in addition to the glass tube portion corresponding to the position of the bead glass, portions of the glass tube more toward a center of the glass tube in the tube axis direction than the bead glass are also shrunk.

Here, in the external electrode fluorescent lamp, the external electrodes are provided as close to the ends of the glass container as possible in order to ensure an effective emission length (a distance between the external electrodes in the tube axis direction) without extending the total length of the external electrode fluorescent lamp.

However, when external electrodes are provided as such in an external electrode fluorescent lamp that has a glass container manufactured by the aforementioned method, discharges occur between the external electrode and the glass container, thereby generating ozone with a strong ability to oxidize.

In view of the above issue, embodiment 8 aims to provide an external electrode fluorescent lamp and a manufacturing method therefor that can prevent discharges from occurring between the external electrodes and the glass container.

The following describes embodiment 8 with reference to the drawings.

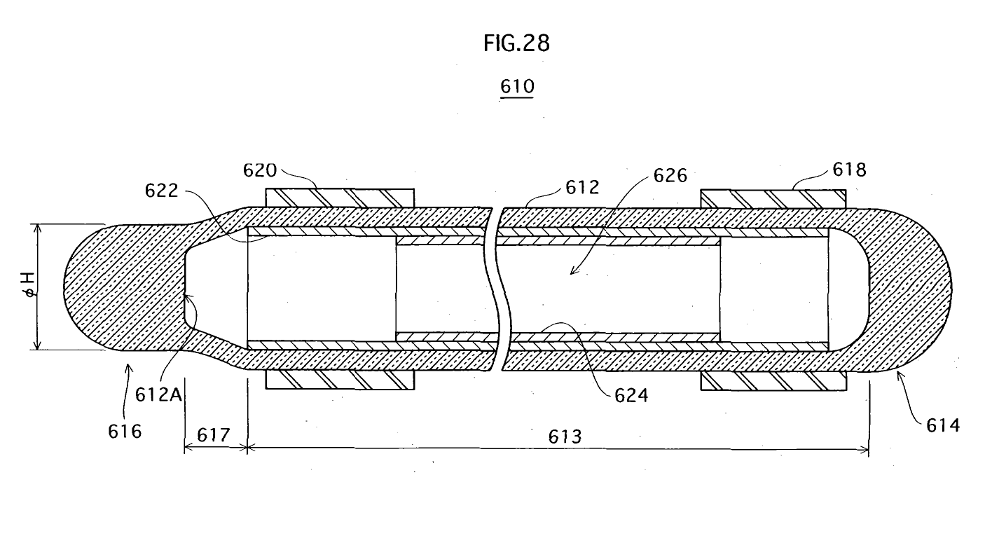

FIG. 28 is a cross-sectional view of an external electrode fluorescent lamp 610 (hereinafter, simply called the “fluorescent lamp 610”) pertaining to the present embodiment, including a tube axis thereof. Note that the scale in the FIG. 28 is not uniform for all constituent elements.

The fluorescent lamp 610 includes a tube-shaped glass container 612 (hereinafter, simply called the “glass container 612”) composed of a glass tube that has a circular cross section and whose ends have been sealed. The glass container 612 is composed of borosilicate glass, and has a length of 700 [mm], an outer diameter of 4.0 [mm] at a straight part 13, an inner diameter of 3.0 [mm], and a thickness of 0.5 [mm]. Note that the present invention is particularly favorably applicable to a lamp having a glass container whose thickness is 0.1 [mm] to 0.7 [mm] inclusive. Furthermore, it is preferable for the thickness of the glass container to be 0.2 [mm] to 0.5 [mm] inclusive. Although a later-mentioned protective film 622 is provided on the glass container, if a thickness of the glass container is less than 0.2 [mm], it is easy for holes to form in inner circumferential portions of the glass container 612 corresponding to positions of later-mentioned first and second external electrodes 618 and 620 due to bombardment by discharges during operation of the fluorescent lamp 610. Also, it is preferable for the thickness to be 0.5 [mm] or less in consideration of the cost of materials.

A first sealed part 614, which is one end portion of the glass container 612, is semispherical in shape. A second sealed part 616, which is the other end of the glass container 612, is bullet-shaped. An outer diameter FH of the second sealed part 616 is 3 [mm], which is smaller than the 4.0 [mm] outer diameter of the straight part 13. A range indicated by the notation 617 in the tube axis direction of the glass container 612 (i.e., a range from an inner edge 612A of the glass container 612 to the straight part 613) is given a substantially tapered shape in which the diameter increases from the inner edge 612A of the glass container 612 toward a center in the tube axis direction (hereinafter, this portion is simply called a “tapered part 617”). Note that beside the aforementioned material, the glass container 612 may be composed of quartz glass, soda glass, lead-free glass, lead glass, or the like.

A first external electrode 618 and a second external electrode 620 are formed on an outer circumference of end portions of the glass container 612. The first and second external electrodes 618 and 620 have a width (a length in the tube axis direction of the glass container 612) of 25 [mm], and are formed so as to encompass an entire circumference of the glass container 612. Note that although not depicted, the first and second external electrodes 618 and 620 have a 2-layered structure. The layer that is closer to the glass container 612 is formed from a silver (Ag) paste film, and the layer further away from the glass container 552 is formed from a lead (Pb) free solder film. Screen printing is used to form the silver paste film and the lead-free solder film on the outer circumference of the glass container 612. Note that the first and second external electrodes 618 and 620 are not limited to having a 2-layered structure. Either may have a single-layer structure. Also, the first and second external electrodes 618 and 620 are not limited to the aforementioned materials. The first and second external electrodes 618 and 620 may be formed by, for example, winding a metallic tape composed of copper, aluminum, etc. around an external circumference of the glass container 612.

A protective film 622 composed of the metal oxide yttrium oxide (Y₂O₃) is formed on substantially an entire surface of the inner circumferential surface of the glass container 612, including portions thereof that oppose the first and second external electrodes 618 and 620. The protective film 622 protects the inner circumferential surface of the glass container 612 from bombardment by electrons and ions during discharges. It is preferable for the protective film 622 to have a thickness of 0.1 [μm] or more, and it is further preferable for the thickness to be 0.5 [μm] or more. Also, with respect to the tube axis direction, a position of an edge of the protective layer 622 on the second sealed part 616 is closer to the second sealed part 616 than a position of an edge of the second external electrodes 620 on the second sealed part 616 side. In other words, with respect to the tube axis direction, the position of the edge of the second external electrode 620 on the second sealed part 616 side is closer to the center of the glass tube than the position of the edge of the protective film 622 on the second sealed part 616 side. As is mentioned later, given that the tapered part 617 is not formed where the protective film 622 lies, the second external electrode 620 does not overlap the tapered part 617 due to being disposed more toward the center of the glass tube than the protective film 622. Note that rather than the aforementioned material, the metal oxide from which the protective film 622 is formed can be alumina (Al₂O₃), silica (SiO₂), or the like.

A phosphor layer 624 is formed on an inner side of the protective film 622 by lamination. The phosphor layer 624 is formed between the first and second external electrodes 618 and 620 in the longitudinal direction (tube axis direction) of the glass container 612. Note that as shown in FIG. 28, portions of the phosphor layer 624 may overlap an inner circumferential surface portion of the glass container 612 that opposes the first and second external electrodes 618 and 620. The phosphor layer 624 includes red (R), green (G), and blue (B) rare earth phosphor particles, and overall emits white light. As one example, the red phosphor particles are composed of YOX (Y₂O₃:Eu³⁺), the green phosphor particles are composed of LAP (LaPO₄:Ce³⁺, Tb³⁺), and the green phosphor particles are composed of BAM (BaMg₂Al₁₆O₂₇:Eu²⁺, Mn²⁺). Similarly to embodiment 1, the phosphor particles are spanned by rod-shaped bodies including a metal oxide.

Also, a predetermined amount (e.g., 3 [mg]) of mercury and a mixture of rare gases (neither are depicted) are enclosed in the glass container 612, that is, in a hermitically discharge space 626, at a predetermined pressure (e.g., 6.8 [kpa]). The mixture of rare gases may be, for example, a neon-argon mixed gas.

Upon applying a high frequency/high voltage alternating current to the first and second external electrodes 618 and 620 in the fluorescent lamp 610 having the aforementioned structure, dielectric polarization occurs at portions of the glass container 612 directly below the first and second external electrodes 618 and 620, and the inner wall of the glass container 552 at such portions acts as an electrode. As a result, a high voltage is induced in the glass container 612, a dielectric barrier discharge occurs therein, thereby emitting ultraviolet radiation which is converted into visible by phosphor layer 624. This visible light is emitted out of the glass container 612.

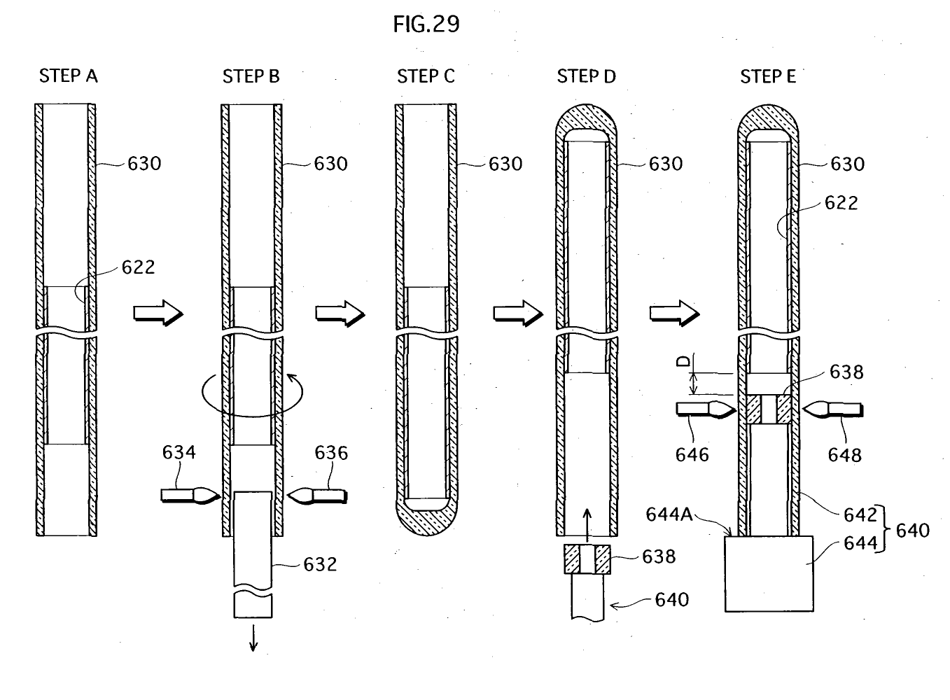

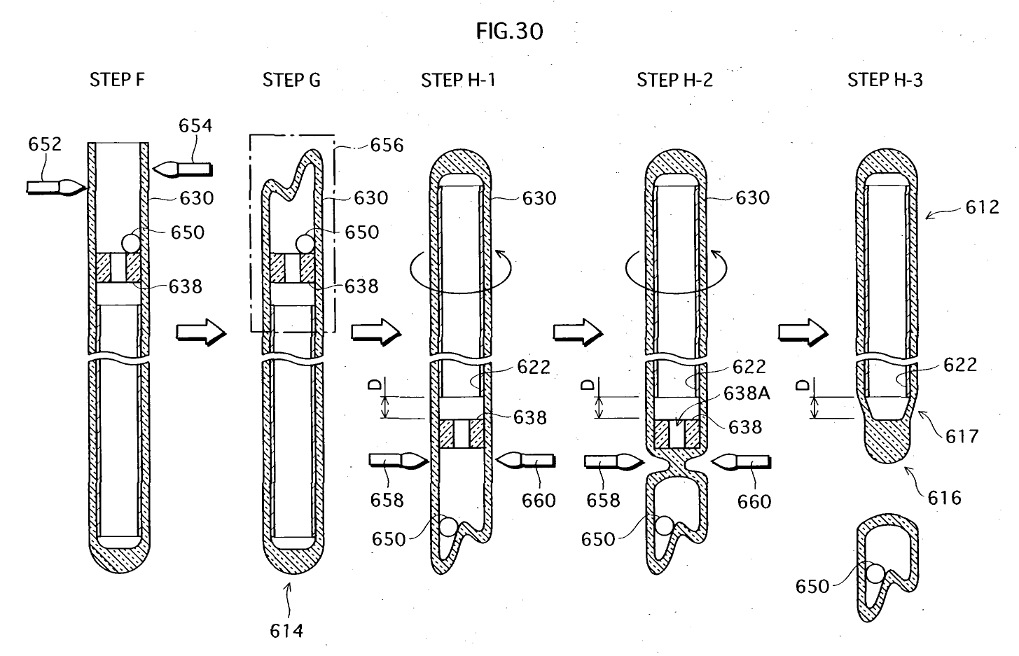

Next is a description of a manufacturing method for the fluorescent lamp 610 with reference to FIG. 29 and FIG. 30.

As shown in FIG. 29, first there is provided a glass tube 630 that has a circular cross-section and a total length of 776 [mm], and the protective film 622 has been formed on an inner circumferential surface of the glass tube 630, excluding end portions thereof (step A). The end portions are excluded from the formation of the protective film 622 because any material other than glass at the ends has a negative affect on sealing with is mentioned later. As is clear from its aim, the protective film 622 need only be formed in areas which oppose the external electrodes, and it is not necessary to form the protective film 622 over an entire length of the glass tube 630, excluding the end portions. Note that although the phosphor layer 624 (FIG. 28) has already been formed on the inner side of the protective film 622 at this stage, the phosphor layer 624 is not depicted in FIG. 29 or FIG. 30 in order to avoid complication.

Next, one end (the bottom end) of the glass tube 630 is sealed by a so-called drop-seal method (steps B and C). First, a metal rod 632 is inserted in the one end of the glass tube 630, and thereafter burners 634 and 636 are used to externally heat the glass tube 630 in a vicinity of the top of the metal rod 632. At this time, the glass tube 630 is rotated around its tube axis, and the metal rod 632 is moved downward (step B). Since an outer diameter of the metal rod 632 is adjacent to the inner diameter of the glass tube 630, the heated portions of the glass tube 630 first soften and attach to the metal rod 632. As the metal rod 632 is pulled, the softened and melted portions of the glass tube 630 are stretched and eventually separate. Then as heat is applied to the bottom end of the glass tube 630, the melted glass forms a semi-sphere due to surface tension, thereby sealing the bottom end and forming the first sealed part 614 (FIG. 28) (step C). Note that the first sealing step (steps B and C) is performed while the pressure in the glass tube 630 is at atmospheric pressure.

When step C ends, the glass tube 630 is inverted from top to bottom, and bead glass 638 composed of borosilicate glass is inserted into the unsealed bottom end (step D). The bead glass 638 is a hollow circular column with a total length of 2.0 [mm], an outer diameter of 2.7 [mm], and an inner diameter of 1.05 [mm]. The bead glass 638 is inserted by being placed on a top edge of a metallic insert rode 640 that is then inserted into the glass tube 630. The insert rod 630 has a narrow-diameter portion 642 that is narrower than the inner diameter of the glass tube 630, and a wide-diameter portion 644 that is wider than the outer diameter of the glass tube 630. The bead glass 638 is placed on the top edge of the narrow-diameter portion 644, and the insert rod 640 is inserted into the glass tube 630 until a top edge 644 of the wide-diameter portion 644 contacts the bottom edge of the glass tube 630. With these two edges in contact, a top edge (the top in the insertion direction) of the bead glass 638 is positioned at a predetermined distance D from the protective film 622 in the tube axis direction. The distance D is described later.

With the bead glass 638 inserted into the glass tube 630 and positioned at a predetermined position, the bead glass 638 is tentatively fixed (step E). The tentative fixing refers to using burners 646 and 648 to heat outer circumferential portions of the glass tube 630 where the bead glass 638 is located, whereby a portion or an entirety of an outer circumference of the bead glass 638 is affixed to the inner circumferential surface of the glass tube 630. Due to a hollow portion 638A of the beat glass 638, the air permeability of the glass tube 630 in the tube axis direction is maintained even if the entire outer circumference of the bead glass 638 is affixed to the glass tube 630.

Proceeding to FIG. 30, the glass tube 630 is inverted from top to bottom when step E ends, insertion of a mercury pellet 650, filling of the rare gases, and tentative sealing of the top end are performed. First, the mercury pellet 650 is inserted via the top end of the glass tube 630. The mercury pellet is a titanium-tantalum-iron scintered body that has been impregnated with mercury. Next, the interior of the glass tube 630 is evacuated, and the rare gases are filled in to the glass tube 630. Specifically, a head of a supply/drain apparatus which is not depicted is placed at the top end portion of the glass tube 630, and after evacuating the interior of the glass tube 630 to create a vacuum, the rare gases are filled until the internal pressure of the glass tube 630 is 6.8 [kpa]. With the rare gases filled, burners 652 and 654 are used to heat the top end portions of the glass tube 630, thereby tentatively sealing the glass tube 630. Since the interior of the glass tube 630 has a negative pressure (6.8 [kPa]), portions of the glass tube 630 that were softened or melted by the heated from the burners 652 and 654 are squeezed by the pressure of the atmosphere and combine to form a seal.

After the tentative sealing, a high-frequency oscillating coil (not depicted) disposed around the glass tube 630 is used to induction-heat the mercury pellet 650 to expel the mercury from the scintered body (mercury extraction step). Thereafter, the glass tube 630 is heated in a heating furnace 656 to cause the expelled mercury to move to a region to be the discharge space of the glass tube 630 (the space between the bead glass 638 and the first sealed portion 614) (step G).

When step G ends, the glass tube 630 is inverted from top to bottom, and the mercury pellet 650 is dropped to the bottom of the glass tube 630 to distance it from the bead glass 638. The second sealing of the glass tube 630 while maintaining this state (steps H-1 to H-3). Burners 658 and 660 are used to externally heat portions of the glass tube 630 in the vicinity of the bottom end of the bead glass 638, while rotating the glass tube 630 in the tube axis direction (step H-1). The heat-softened portions of the glass tube 630 are squeezed and constricted by the pressure of the atmosphere since the interior of the glass tube 630 has a negative pressure (step H-2). Upon applying further heat, the heated portions of the glass tube 630 melts with the bead glass 638, the melted portion of the glass tube 630 is sucked into the hollow part 638A of the bead glass 638, thereby shrinking the hollow part 638A. The melted portion of the glass tube 630 and the melted bead glass 638 unite to form a seal, thereby completing the glass container 612 in which both ends are sealed (step H-3). It is inferred that during the second sealing, the tapered part 617 (see FIG. 28 as well) is formed by the pulling of the bead glass 638 whose diameter shrinks.

Thereafter, the first and second external electrodes 618 and 620 are formed on an outer circumference of the ends of the completed glass container 612, thereby completing the fluorescent lamp 610. At this time, the second external electrode 620 is formed more toward the center of the glass tube in the tube axis direction than the tapered part 617 (see FIG. 28 as well), and not in the tapered part 617 due to the following reasons.

In other words, when there is an overlapping portion of the tapered part and the external electrodes in the case of the external electrodes being formed from metallic tape (a metal foil), there will be a gap at the overlapping portion between the external electrode and the outer circumferential surface of the glass tube. When there is a gap, a discharge occurs between the external electrode and the glass container at the gap portion, thereby producing ozone which has a strong ability to oxidize.

Also, a similar phenomenon occurs when screen printing is used to apply a metallic paste to the outer circumferential surface of the glass tube to form the external electrodes.

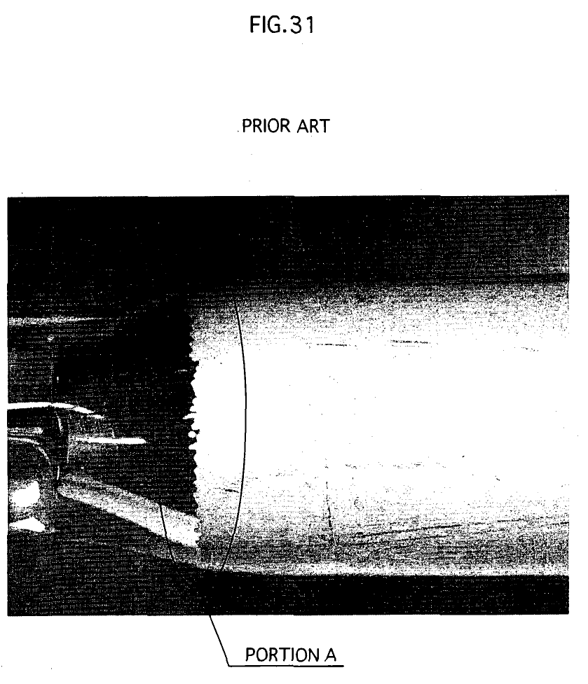

If screen printing is used to apply the metallic paste, irregularities appear in the metallic paste at the tapered portion whose application surface shape is unstable, or the edge of the metallic paste becomes jagged like saw teeth as in portion A shown in the photograph of FIG. 31. Discharges will occur between the outer circumferential surface of the glass container and the pointed portions of the external electrode edges formed in the shape of saw teeth, thereby producing ozone.

At any rate, the external electrodes are formed on the straight part 613 and not on the tapered part 617 in view of the above constraints. In other words, it can be said that the tapered part is unnecessary, and it is preferable for the tapered part to be as short as possible.

The inventors of the present invention found that applying the following method enables the tapered part to be shortened as much as possible.

Specifically, the inventors of the present invention found that performing the second sealing with the top edge (in the insertion direction) of the bead glass 638 as close as possible in the tube axis direction to the protective film 622 enables the tapered portion to be shortened.

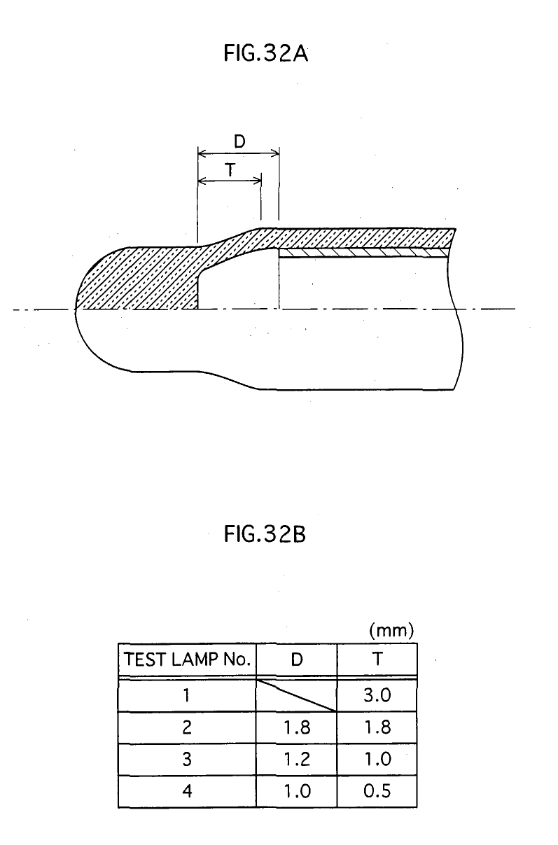

The inventors measured a length T of the tapered part when changing the distance D between the top edge (in the insertion direction) of the bead glass 638 and the protective film. Specifically, the inventors examined a relationship between the distances D and T shown in FIG. 32A. In this examination, distances T were examined after manufacturing a lamp in which the second sealing was performed without forming the protective film (called lamp No. 1), and manufacturing lamps in which the second sealing was performed with the distance D set at 1.8 [mm], 1.2 [mm], and 1.0 [mm] (called lamps No. 2, No. 3, and No. 4 respectively). FIG. 32B shows results of the measurements.

T was 3.0 [mm] in the No. 1 experimental lamp. In other words, it was found that the length T of the tapered part was 3.0 [mm] when the protective film is not formed or when the bead glass is sufficiently distanced from the edge to the protective film even if the protective film is formed, as in conventional lamps.

It was then examined how the distance T changed when the distance D was changed to a range below 3.0 [mm].

It can be seen from the results shown in FIG. 32B that the shorter the distance D is, the shorter the length T becomes. Also, it can be seen that T=1.8 [mm] when D=1.8 [mm], making D and T equal, and when the distance D is further shortened to 1.2 [mm] and 1.0 [mm], T becomes less than D.

It is inferred that the following are reasons why it is possible to reduce the length T of the tapered part when the distance D is shortened, that is, when the top edge of the bead (the top edge in the insertion direction) is brought closer to the protective film and the second sealing is performed.

Specifically, in steps H-1 to H-3 of FIG. 30, supposing that the protective film has not been formed, not only the portion of the glass tube that is intended to be directly heated, but also a portion of the glass tube above the bead glass 638 is heated by the burners 658 and 660 and softened. At this time, the bead glass 638 is pulled so as to shrink in the diameter direction, and a majority of the softened portion of the glass tube above the bead glass 638 is shrunk.

In contrast, it is thought that although the portion of the glass tube above the bead glass 638 softens in the same way even if the bead is brought closer to the protective film, the shrinkage of the glass tube can be constrained to only a portion between the protective film and the bead glass since the protective film acts as a reinforcing member to prevent shrinkage of the glass tube. The above point can also be understood from the fact that since the softening point of borosilicate glass is lower than the softening point of the protective film composed of yttrium oxide (Y₂O₃), the protective film remains in a hardened state and maintains its strength even if the glass tube is in a softened state.

Based on the above, making the distance D less than 3 [mm] and performing the second sealing enables the length of the tapered part in the tube axis direction to be shortened more than conventionally possible, thereby making it possible to reduce the total length of the fluorescent lamp.

Also, although it is preferable to reducing the distance D as much as possible in order to shorten the length of the tapered part as mentioned above, sealing defects may appear if the D=0, that is, if the top edge of the bead glass is brought to the same position as the edge of the protective film. In other words, the protective film formed on the inner circumferential surface of the glass tube may become sandwiched between the glass tube and the outer circumference of the bead glass when the sealed part is formed during the second sealing, the sandwiched portion may undermine the hermitic seal. It is therefore preferable for D to be greater than zero.

In consideration of the above, it is preferable for the distance D to be in the range of 0<D<3 [mm], and when the second sealing is performed with the distance D in this range, the tapered part can be shortened in the tube axis direction more than conventionally possible without inviting sealing defects, thereby making it possible to have a fluorescent lamp with a shorter overall length.

(1) Although bead glass is used in only the second sealing in embodiment 8, the present invention is not limited to this. Bead glass may be used in the first sealing. A description of a method of using bead glass in the sealing of both ends of the glass tube is disclosed in, for example, International Published Application 2005/071714 pamphlet, and therefore such description has been omitted.

(2) Although the glass tube is processed while being stood upright in the steps of the manufacturing method pertaining to embodiment 8, the present invention is not limited to this. Processing may be performed while the glass tube has been laid in a horizontal state.

(3) Although embodiment 8 describes an exemplary application of the present invention in an external electrode fluorescent lamp, the present invention is not limited to this. The present invention can be applied in an external electrode ultraviolet radiation lamp. In other words the present invention can be applied in an external electrode ultraviolet radiation lamp that has the structure of the external electrode fluorescent lamp of embodiment 8 from which the phosphor layer has been removed (or the phosphor layer is not formed). An ultraviolet lamp is used to expose an irradiation body to ultraviolet radiation to sterilize the irradiation body.

The phosphor materials forming the phosphor particles are not limited to those described in the above embodiments.

Along with increases in color reproducibility performed as a part of the increasing picture quality in recent years of liquid crystal display apparatuses typified by an LCD TV, there is demand for an extended range of reproducible colors in cold cathode fluorescent lamps and external electrode fluorescent lamps used as light sources in backlight units of these liquid crystal display apparatuses.

Here, compared with the previously mentioned phosphor materials, using the following phosphor materials enables an extended range of colors, that is, an expansion of the NTSC triangle in the CIE 1931 chromaticity map.

The red phosphor material can be selected from the following:

(i) Eu-activated yttrium oxysulfite [Y₂O₂S:Eu³⁺] (abbreviated as YOS), with chromaticity coordinates of x=0.651, y=0.344

(ii) Eu-activated phosphor.vanadium.yttrium oxide [Y (P,V) O₄:Eu³⁺] (abbreviated as YPV), with chromaticity coordinates of x=0.658, y=0.333

(iii) Mn-activated magnesium.magnesium fluoride germanium oxide [3.5 MgO.0.5 MgF₂.GeO₂:Mn⁴⁺] (abbreviated as MFG), with chromaticity coordinates of x=0.711, y=0.287

The green phosphor material can be selected from the following:

(i) Eu/Mn-activated barium magnesium aluminate [BaMg₂Al₁₆O₂₇:Eu²⁺, Mn²⁺] (abbreviated as BAMMn), with chromaticity coordinates of x=0.139, y=0.574

(ii) Mn-activated cerium.magnesium.zinc aluminate [Ce (Mg,Zn)Al₁₁O₁₉:Mn²⁺] (abbreviated as CMZ), with chromaticity coordinates of x=0.164, y=0.722

(iii) Tb-activated cerium.magnesium aluminate [CeMgAl₁₁O₁₉:Tb³⁺] (abbreviated as CAT), with chromaticity coordinates of x=0.267, y=0.663

It should be noted that the chromaticity coordinates of the phosphor materials used in the above embodiments are as follows:

YOX (x=0.644, Y=0.535), LAP (x=0.51, y=0.585), BAM (x=0.148, y=0.056)

Note that the color range is extended if of course the aforementioned phosphor materials of (i) to (iii) are substituted for both YOX and LAP, and even if substituted for only one of these.

Also, the following materials can be used instead of BAM as the blue phosphor material.

(i) lanthanum oxide-attached Eu-activated barium magnesium aluminate [BaMg₂Al₁₆O₂₇:Eu² attached with La2O3] (abbreviated as LaBAM+La₂O₃ coat), with chromaticity coordinates of x=0.148, y=0.156)

LaBAM is particles of Eu-activated barium.magnesium aluminate to which fine particles of the metal oxide lanthanum oxide have been attached. LaBAM has a higher luminance maintenance rate than BAM.

(ii) strontium.calcium.chloroapatatite [(Sr, Ca, Ba)₅(PO4)₃C₁₂:Eu²⁺] (abbreviated as SCA), with chromaticity coordinates of =0.151, y=0.065

Note that the chromaticity coordinate values shown in the aforementioned (3) and (4) are representative values of the phosphor materials, and the chromaticity coordinate values of the phosphor materials may differ slightly from the above values depending on the measuring method (measuring principle).

Furthermore, the phosphor material used to emit red, green, or blue light is not limited to being one type. A combination of phosphor materials may be used to emit red, green, or blue light.

### INDUSTRIAL APPLICABILITY

A fluorescent lamp of the present invention can be used favorably as a light source in a lighting apparatus or the like constituting an illumination apparatus or a display apparatus due to achieving both high luminance and suppression of mercury consumption.

1. A fluorescent lamp, comprising:
a glass container having mercury enclosed therein; and
a phosphor layer formed on an inner side of the glass container, wherein
the phosphor layer contains a plurality of phosphor particles, and a plurality of rod-shaped bodies that include a metal oxide and span between the plurality of phosphor particles.

2. The fluorescent lamp of claim 1, wherein
at least one pair of adjacent phosphor particles is spanned by a plurality of the rod-shaped bodies.

3. The fluorescent lamp of claim 1, wherein
a thickness of each of the rod-shaped bodies is no more than 1.5 [μm].

4. The fluorescent lamp of claim 1, wherein
the metal oxide includes at least one member selected from the group consisting of Y, La, Hf, Mg, Si, Al, P, B, V and Zr.

5. The fluorescent lamp of claim 1, wherein
the metal oxide includes Y₂O₃.

6. The fluorescent lamp of claim 1, wherein
the glass container is tube-shaped and has an inner diameter in a range of 1.2 [mm] to 13.4 [mm] inclusive.

7. The fluorescent lamp of claim 1, wherein
the plurality of phosphor particles is divided into at least two groups, each group having a different progression rate of time degredation caused by the mercury, and
the phosphor particles in the at least one group other than the group having a lowest progression rate of time degredation are covered by individual coating layers that include the metal oxide.

8. The fluorescent lamp of claim 7, wherein
the individual coating layers compose 0.01 [wt %] to 1.5 [wt %] inclusive of a total weight composition of the plurality of phosphor particles.

9. The fluorescent lamp of claim 1, wherein
an activator has been added to the metal oxide such that the rod-shaped bodies emit light due to excitation by ultraviolet radiation.

10. The fluorescent lamp of claim 9, wherein
the activator is at least one member selected from the group consisting of europium, cerium, terbium, gadolinium, titanium, zirconium, vanadium, niobium, tantalum, molybdenum, tungsten, lanthanum, praseodymium, neodymium, samarium, dysprosium, holmium, erbium, thulium, ytterbium and lutetium.

11. The fluorescent lamp of claim 1, wherein
a material of the glass container includes a glass composed of 3 [mol %] to 20 [mol %] inclusive of sodium oxide.

12. The fluorescent lamp of claim 1, further comprising:
an external electrodes, wherein
the glass container is a tube-shaped glass container, a first end and a second end thereof having been sealed,
the external electrode is provided on an outer circumference of a portion of the first end,
the glass container has, at a part of the first end, a tapered portion whose diameter increases from an inner end of the tube-shaped glass container toward a central portion in a tube axis direction, and
the external electrode is formed further toward the central portion in the tube axis direction than the tapered portion.

13. The fluorescent lamp of claim 12, further comprising:
a protective film formed on an inner circumference of the tube-shaped glass container, wherein
the protective film is formed such that an end thereof toward the first end in the tube axis direction is positioned closer to the first end than an end of the external electrode toward the tapered portion.

14. The fluorescent lamp of claim 1, wherein
the plurality of phosphor particles includes phosphor particles that emit red light, phosphor particles that emit green light, and phosphor particles that emit blue light,
the phosphor particles that emit red light are formed from a phosphor material selected from the group consisting of Eu-activated yttrium oxysulfite, Eu-activated phosphor vanadium yttrium oxide, and Mn-activated magnesium oxide magnesium fluoride germanium oxide, and
the phosphor particles that emit green light are formed from a phosphor material selected from the group consisting of Eu/Mn-activated barium magnesium aluminate, Mn-activated cerium magnesium zinc aluminate, and Tb-activated cerium magnesium aluminate.

15. A manufacturing method for a fluorescent lamp, comprising:
a coating-material formation step of forming a coating material by (i) dispersing phosphor particles in a mixed solvent including at least two solvents, each solvent having a different boiling point, and (ii) dissolving a metal compound in the mixed solvent; and
a phosphor layer formation step of forming a phosphor layer by applying the coating material to an inner side of a glass container, drying the applied coating material, and heating the dried coating material to form a metal oxide from the metal compound.

16. The manufacturing method for a fluorescent lamp of claim 15, wherein
the metal compound is an organic metal compound.

17. The manufacturing method for a fluorescent lamp of claim 16, wherein
the organic metal compound includes yttrium carboxylate.

18. The manufacturing method for a fluorescent lamp of claim 17, wherein
in the phosphor layer formation step, gas with a humidity in a range of 10[%] to 40[%] at 25 [° C.] is supplied into the glass container while drying the coating material.

19. A lighting apparatus, comprising:
a plurality of the fluorescent lamps of claim 1; and
a casing storing therein the plurality of fluorescent lamps and including a window able to transmit light emitted by the plurality of fluorescent lamps.

20. A display apparatus, comprising:
a display panel; and
the lighting apparatus of claim 19 disposed on a back surface of the display panel.
